(19) United States
(12) Patent Application Publication
(10) Pub. No.: US 2003/0208392 A1
(43) Pub. Date: Nov. 6, 2003

(54) Optimizing resource plans

(75) Inventors: Konanur C. Shekar, North Potomac, MD (US); Salil Joshi, Rockville, MD (US); Michael Hooks, Germantown, MD (US); Ingrid Bongartz, Kanata (CA); Robert MacMillan, Ottawa (CA); Chris Greamo, Washington, DC (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 10/287,774

(22) Filed: Nov. 5, 2002

Related U.S. Application Data
(63) Continuation-in-part of application No. 09/984,327, filed on Oct. 29, 2001.
(60) Provisional application No. 60/243,426, filed on Oct. 27, 2000.
(60) Provisional application No. 60/330,956, filed on Nov. 5, 2001.

(51) Int. Cl. G06F 17/60

(52) U.S. Cl. 705/8

(57) ABSTRACT

The present invention relates to a master resource planning systems and related methods for optimizing resource plans across multiple networks. In particular, the present invention optimizes constrained resources across multiple networks and produces an optimized plan to allocate and coordinate the obtaining, shipping and procurement of limited resources based upon user-defined strategies and supplier/shipper preferences Aspects of the disclosure include creating planning data and planning rules. Planning data contains information regarding constrained resources in the multiple networks. Planning rules are based on user-defined strategies. Additional aspects include generating a plan based on the planning data and the planning rules and revising the plan in real-time. The generated plan optimally allocates the constrained resources according to the user-defined strategies. Certain embodiments disclosed herein employ pegging strategies for handling over and under availability of demanded resources among a variety of competing orders. Other certain embodiments disclosed herein optimize the procurement of resources needed to fulfill orders in part by taking into account limitations in shipping lag times, established transportation schedules, and carrier preferences.

### CROSS-REFERENCE TO RELATED APPLICATIONS

This application is a continuation-in-part of U.S. patent application Ser. No. 09/984,327, filed Oct. 29, 2001, which application in turn claimed benefit of the filing date of U.S. provisional patent application Serial No. 60/243,426, filed Oct. 27, 2000. This application also claims the benefit of the filing date of U.S. provisional patent application Serial No. 60/330,956, filed Nov. 5, 2001, the entirety of which is herein incorporated by reference.

### FIELD OF THE INVENTION

The present invention relates to a master resource planning systems and related methods for optimizing resource plans. In particular, the present invention optimizes constrained resources across multiple networks and produces an optimized plan to allocate and coordinate the obtaining, shipping and procurement of limited resources based upon user-defined strategies and supplier/shipper preferences

### DISCUSSION OF THE RELATED ART

Organizations have many business strategies available to efficiently use constrained resources. Examples of such business strategies include bill-to-order, make-to-stock, vendor managed inventory, or continuous replenishment planning. However, the complexity of developing, implementing and managing constrained resources in a distributed environment often makes it difficult to effectively apply such business strategies to devise plans to effectively utilize constrained resources to meet forecasted or customer demands.

Customer-focus coordination across multi-site manufacturing, supply, distribution, and transportation constraints is critical to improving revenues, decreasing inventory and maintaining production efficiencies. A solution that optimizes constraints in real times as challenges occur is key to minimizing asset investment and increasing customer service and profit.

Resource optimization planning in modern, complex multi-site enterprises requires the balancing of many factors relating to different products, suppliers, and methods of procurement, manufacture and delivery. To make resource optimization possible, current methodologies often make key assumptions in order to simplify the number of variables that must be considered and decisions that must be made, and therefore solutions that must be compared, when optimizing resource plans.

In particular, it is commonplace for multi-site manufacturing, supply and distribution chains to encounter situations where the manufacturing location or supply point of a particular item is remote from the location of its demand or need. Thus, transportation services are necessarily required to enable the enterprise's supply chain. Commonly, resource optimization planning methodologies and tools make the assumption that the transportation lead-time between a supplier location and a demand (i.e., purchase or end-user) location is fixed. Unfortunately, it is often the case that this assumption is invalid and thereby introduces significant errors into the resource planning process as necessary supplies are received after their allocated window of need has expired. Specifically, transportation carriers often require different lead times from trip to trip. Some carriers make certain trips direct one from the supply location to the demand location, while other carriers stop at a third location on their way to the demand location, resulting sometimes in undesirable delay. Thus, the lead times vary from one trip to another depending upon carrier and delivery date and time. For example, an otherwise feasible capacity plan generated by contemporary resources planning methodology may not be an adequate plan from a transportation perspective. This could be the case where a particular supply that was scheduled for arrival according to just in time (“JIT”) usage principles with certain transportation lead time assumptions may actually require a larger buffer during planning of the window of need in order to prevent the supply item from either being held in inventory or arriving late due to lead time variability. It would therefore be preferable if appropriate transportation inputs were utilized in resource planning such that a feasible plan was optimized from both a capacity and carrier perspective.

Additionally, it is commonplace for multi-site manufacturing, supply and distribution chains to encounter situations where the demand for supply goods is unmatched in time and availability with available supply from regular supply sources. Conceivably, the enterprise could have a variety of responses to such scenarios, including seeking alternate suppliers, stocking excess supply, and allocating the under-supply in various manners (evenly, prioritizing, weighting, etc.) across competing needs. Contemporary resource optimization planning methodologies and tools have been unsuccessful in providing the capability to adequately facilitate the handling of such over-supply and under-supply scenarios according to the current business strategies and priorities of the enterprise.

Thus, there is a need for a system and method for optimizing resource plans by allocating critical resources across the network, devising an optimized plan to allocate and coordinate limited resources based upon business strategies, and for simultaneously optimizing constraints across multi-site networks, including manufacturing, distribution, and supply networks. Further, there is a need for systems and methods for optimizing resource plans by utilizing published transportation schedules of selected carriers in advance to arrive at a feasible plan from both a capacity and carrier perspective. Additionally, there is a need for systems and methods for optimizing resource plans that provide flexible control over the handling of mismatches of current demand and available supply in a supply chain.

### SUMMARY OF THE INVENTION

In light of the above-described and other disadvantages inherent in the prior art, the present invention utilizes a cluster availability model to provide methodologies and tools for optimizing resource plans to be used by enterprises having complex multi-site manufacturing, supply and distribution chains. In particular, the present invention provides a method and system for modeling availability of a cluster with software components with at least one node in a computationally feasible manner without sacrificing the flexibility to accurately consider the current business goals, strategies and decisions of the enterprise between and among competing resource requirements.

To achieve these and other advantages and in accordance with the purposes of the present invention as embodied and broadly described herein, the present invention includes a method for optimizing resource plans across multiple networks. The multiple-networks include manufacturing, distribution, and supplier networks. The method includes creating planning data and planning rules. The planning data contains information regarding constrained resources. The planning rules are based on user-defined strategies. The method also includes generating a plan based on the planning data and the planning rules and revising the plan in real-time. The generated plan optimally allocates the constrained resources according to the user-defined strategies.

In another aspect, the invention includes a system for optimizing resource plans across multiple networks including manufacturing, distribution, and supplier networks. The system includes means for creating planning data and planning rules. The planning data contains information regarding constrained resources. The planning rules are based on user-defined strategies. The system also includes means for generating a plan based on the planning data and the planning rules. The plan optimally allocates the constrained resources according to the user-defined strategies. In addition, the system includes means for revising the plan in real-time.

In further aspects, the invention includes a computer program product including a computer usable medium with computer readable code for optimizing resource plans across multiple networks. The multiple-networks include manufacturing, distribution, and supplier networks. The steps effective by the computer program product running on a computer include creating planning data and planning rules. The planning data contains information regarding constrained resources. The planning rules are based on user-defined strategies. Additionally, the steps include generating a plan based on the planning data and the planning rules and revising the plan in real-time. The generated plan optimally allocates the constrained resources according to the user-defined strategies.

Preferred embodiments according to another aspect of the invention relate to a method for optimizing resource plans across a multi-location supply network where the network includes locations for multiple supply points and at least one location for a demand point. The supply point provides supply items needed by said demand point according to resource plans. The methods according to this aspect of the invention comprise creating planning data which contains information regarding constrained resources and where the constrained resources including vessel scheduling information for transporting the supply items from the supply points to the demand point. Planning rules are created based on user-defined strategies, and the planning rules identify acceptable timeframes in which supplies of the supply items must arrive at the demand point in order to meet consumption dates for given orders. A plan is then generated based on the planning data and the planning rules, wherein the plan optimally allocates the constrained resources according to the user-defined strategies. This plan provides required consumption dates of any supply items. The plan is thereafter revised in real-time as necessary. Aspects of the invention also relate to systems for optimizing resource plans and computer program products adapted to carry out this method.

Additional features and advantages of the invention are set forth in the description that follows, and in part are apparent from the description, or may be learned by practice of the invention. The objectives and other advantages of the invention are realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description, serve to explain the principles of the invention. In the drawings:

FIG. 1 is a representational diagram illustrating functions in one embodiment of the present invention used to optimize resources across multiple networks;

FIG. 2 is a flow diagram showing operations performed by one embodiment of the present invention in devising a plan to optimize resources;

FIG. 3 is a representational diagram describing operations that may be performed to improve a master plan generated by one embodiment of the present invention;

FIG. 4 is a flow diagram depicting operations that may be performed by one embodiment of the present invention to optimize resource plans in a multi-network environment;

FIG. 5 is a representational diagram illustrating various shipping lane alternatives and supplier/buyer relationships that may occur between various locations in an example of a supply chain network;

FIG. 6B is a representational diagram showing one embodiment of the present invention in terms of user views and perspectives;

FIG. 6A is a representational diagram showing a computational environment in which one embodiment of the present invention may be used;

FIGS. 7A and 7B are representational diagrams illustrating resource allocation and substitution that may occur in planning and scheduling stages;

FIG. 8 is a representational diagram illustrating relationships between aggregate stock keeping units and lower-level stock-keeping units;

FIG. 9 is a representational diagram depicting resource-load-based view that may be shown using one embodiment of the present invention;

FIG. 10 is a flow diagram showing operations that may be performed in removing excess supply orders using one embodiment of the present invention;

FIGS. 11A, 11B, and 11C are representational diagrams showing loading strategies that may be used in the present invention; and

FIGS. 12A, 12B, and 12C are representational diagrams showing additional loading strategies that may be used in the present invention.

### DESCRIPTION OF THE PREFERRED EMBODIMENTS

Reference is now made in detail to the preferred embodiments of the present invention, examples of which are illustrated in the drawings.

As explained in detail below, the present invention may be used to simultaneously optimize the use of constrained resources to improve customer service and profit while reducing asset investment. It may also be used to provide simultaneous optimization of materials, capacity, inventory, transportation, and distribution constraints across multi-site manufacturing, distribution, and supply networks.

Further, as events such as production breakdowns, distribution delays, or material shortages occur within the trading network, the present invention may send an alert and employ appropriate optimization to address the plan to meet customer commitments. This coordinated, synchronized response enables one to quickly capitalize on new revenue opportunities and identify and overcome trading challenges. A real time graphical support may be provided to identify constraints through the network, by item, by customer, and by location, for example, for quicker resolution and easier drill-down.

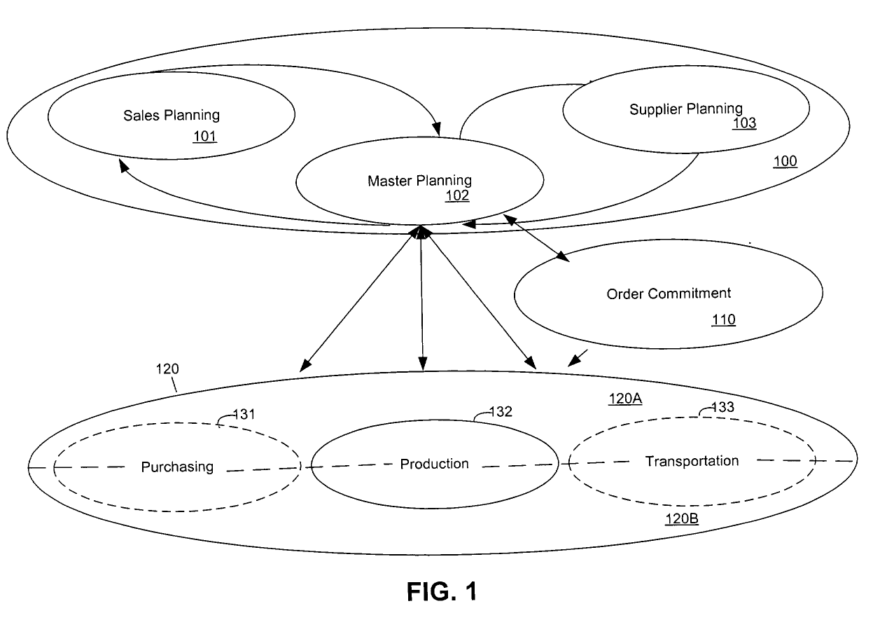

FIG. 1 is a simplified representational diagram showing some of the functions performed by one embodiment of the present invention to resolve a complex problem of optimizing resource plans across multiple networks based on user-defined strategies. In FIG. 1, supply is created within the boundaries of some agreed policies and constraints to optimize the plan across all aspects of an organization's supply chain as explained in detail below.

In order to produce an optimized plan that takes into account various aspects of an organization's supply chain, an enterprise planning solution 100 may include various types of planning modules, including a sales planning module 101, a master planning module 102, and a supplier planning module 103. The sales planning module 101 may be used to produce a forecast by product, channel, or region. The mater planning module 102 (also referred to herein simply as “master planning”) comprises master planning processes having various routines which operate to use the information from the sales planing module 101 to generate a plan to meet forecasted demands. It may also produce supplier requirements, which may be used by the supplier planning module 103. The supplier planning module 103 may provide suppler agreements to master planning module 102. Master planning module 102 may also supply production allocated to channels that could expose potential gaps in supply meeting demand to the supply planning module 103.

An order commitment 110, by communicating with master planning module 102 may use the plan information provided by master planning module 102 to ensure accurate commitment responses.

An order fulfillment 120 exchange information with master planning module 102. In fulfilling an order based on the plan or plans produced by master planning module 102, actions such as buy, make, and move may be taken, corresponding to a purchasing 131, production 132, and transportation 133, respectively. The order fulfillment 120 may include a pre-order fulfillment 120A and an integrated order fulfillment 120B.

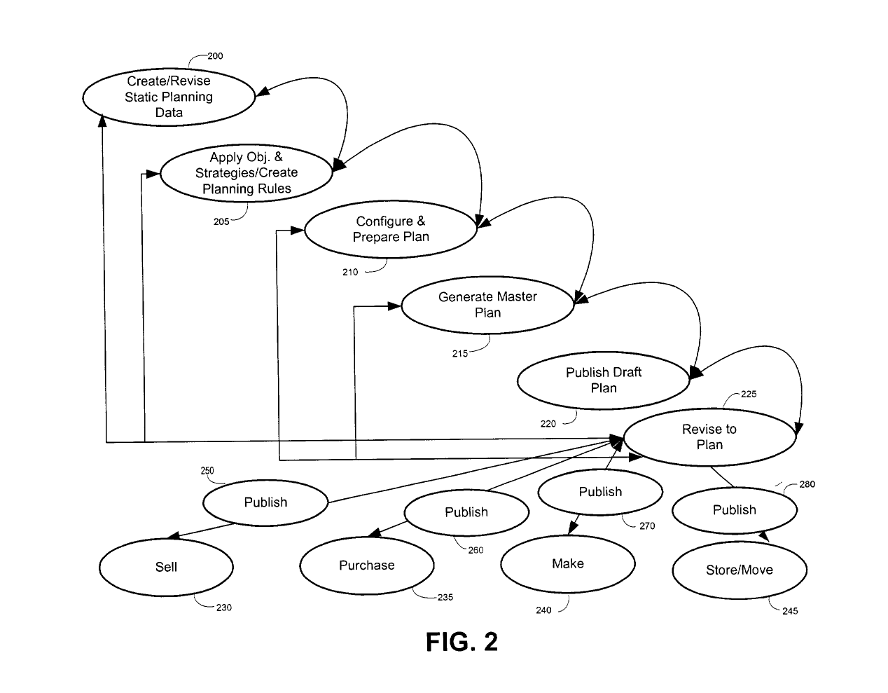

FIG. 2 is a flow diagram showing operations involved in one embodiment of the present invention. At step 200, static planning data is created and/or revised. To accurately model a supply chain at the planning stage, one may consider various static and dynamic factors. Static factors may include locations, items, stock keeping units (“SKUs”), recourses, lanes, processes, bill of materials, bill of routing, etc. Dynamic factors may include shipping and receiving calendars, effectivity calendars, manufacturing availability calendars, constraint settings, etc. These factors may be revised to accurately reflect the current status of the supply chain.

At step 205, planning rules may be created by applying objectives and strategies. Objectives and strategies may be used as a basis to measure critical success factors. Success factors may be based on cost (revenue or margin), capacities (such as minimizing inventory held at a location, or resource utilization), or maximizing customer strategies. Planning strategies may be pointers for the plan to achieve the objective set forth for an organization. Strategy settings for such plan strategies may include, for example, make-to-stock (“MTS”), make-to-order (“MTO”), and/or assemble-to-order (“ATO”).

A user may set up rules and strategies to meet his or her business objectives. This may include setting up, for example, MTO/ATO strategy for a one group of SKUs while assigning another strategy to another group, and defining sourcing splits between multiple locations that make the same item. A user may also define safety stock rules for a group of SKUs or family of items.

At step 210, a plan may be prepared and/or configured based on static planning data and planning rules. At step 215, a master plan is generated. The master plan (or the draft master plan) is published and revised at steps 220 and 225, respectively. Based on the revised plan the following operations may be performed, sell (230), purchase (235), make (240), and store/move (245). Prior to performing these operations, the revised plan or portions of the revised plan may be published at steps 250, 260, 270, and 280.

FIG. 2 also shows how one or more operations may interact with each other. For example, the generating master plan step 215 may interact with the steps 210, 220, and 225. By allowing such interactions, the present invention allows resource plans to be optimized flexibly and adopt to changing circumstances in real-time.

Steps shown in FIG. 2 may be performed at various frequencies. For example, they may be performed throughout a planning cycle, quarterly per planning cycle, at the beginning of a planning cycle, periodically (e.g., weekly, monthly, or quarterly), or some fixed number of days after running a plan.

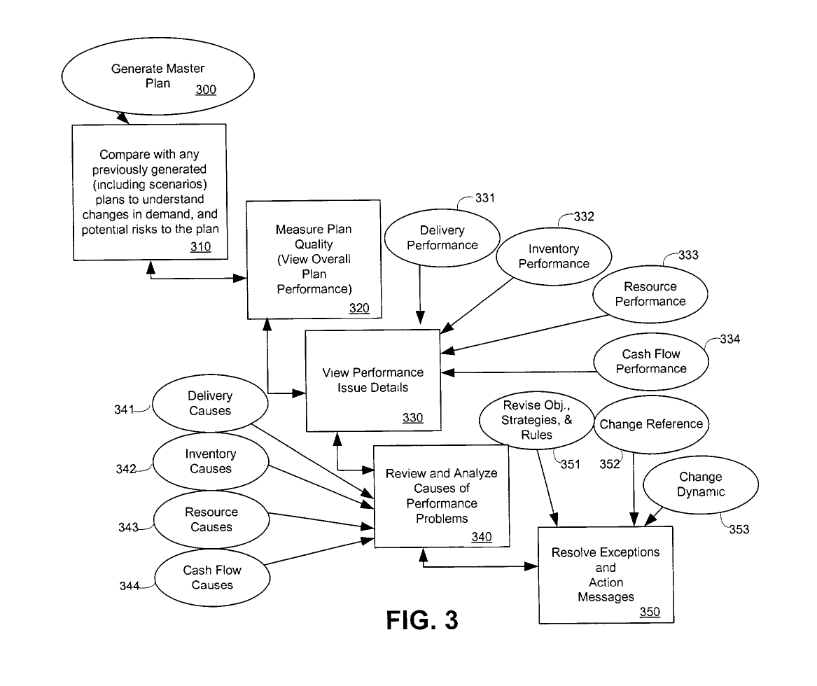

FIG. 3 shows is a representational diagram showing operations that may be performed to improve a master plan generated by one embodiment of the present invention. A generated master plan 300 may be compared with any previously generated plans and/or scenarios to understand, for example, changes in demand, potential risks to the plan, etc. (step 310). Plan qualities may be assessed at step 320. In so doing, one may view various aspects of the plan performance such as an overall plan performance.

At step 330, details of plan performance may be analyzed. At this step, one may take into account such factors as delivery performance 331, inventory performance 332, resource performance 333, and cash flow performance 334. The delivery performance 331 may deal with customer service and on time delivery of customer orders. It may include information regarding demand (e.g., total customer demand, non-consumed forecast, late demand), customer orders (e.g., sales revenues, delivery performance, and average and maximum lateness), supply orders (e.g., late supply orders, average and maximum lateness), and causes of lateness. The inventory performance 332 may be based on SKU projections such as inventory value (e.g., average, minimum, and maximum inventory value, variation), demand coverage (e.g., average, minimum, and maximum demand coverage), problems (e.g., periods with negative projective inventory balances or under safety stock), and causes of lateness. The resource performance 333 (or resource utilization performance) may be based on capacity values of a resource, including capacity utilization (e.g., total capacity available, capacity used (hours and/or %), average and maximum capacity), overload/underload (i.e., resources with utilization over or under threshold), and cases of lateness. The cash flow performance 334 (or profit/loss performance) may include factors such as cash-flow-in (e.g., sales revenue, forecasted revenue), cash-flow-out (e.g., operating cost, total purchasing cost), balance (e.g., total, average, minimum, and/or maximum balance), and in-synch indicators (e.g., throughput, operating expense, productivity turns).

At step 340, causes of performance problems may be reviewed and analyzed. Causes of performance problems may include delivery (341), inventory (342), resources (343) and/or cash/flow (344). At step 350, exceptions and action messages that may have been outputted during the plan generation process may be resolved. In resolving exceptions and action messages, one may, for example, revise objectives, strategies, and/or rules (351), change reference (352), and/or change dynamic (353).

An optimized plan (or a master plan) produced by the present invention may explain how to allocate and coordinate limited resources based upon user-defined strategies that may contain information regarding customer, item, and location prioritization, and/or predetermined business goals such as increasing revenues and improving services. Strategies may also reflect information regarding network designs and sourcing policies.

One embodiment of the present invention may be viewed to combine what is traditionally known as material requirements planning (“MRP”), capacity resource planning (“CRP”), and distribution requirements planning (“DRP”) in the area of manufacturing planning and control. By combining distribution requirement planning and material requirements planning, such embodiment advantageously allows creation of a plan that is constrained based on material and resource capacity availability along with the logic of providing distribution plans for a large network.

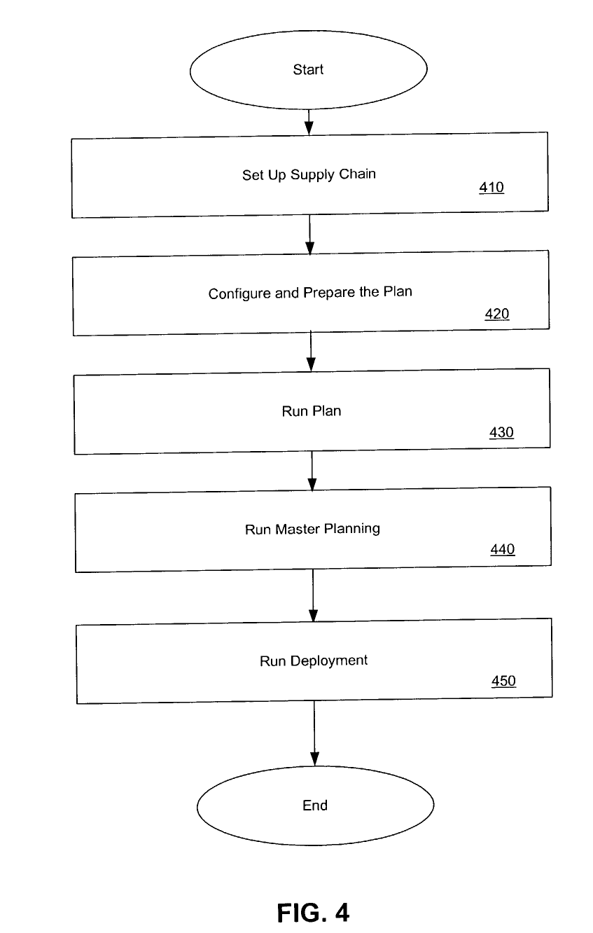

FIG. 4 is a flow diagram showing operations that may be performed by one embodiment of the present invention. At step 410, a supply chain is set up. Specifically, in this step, a user establishes an interface SKU. An interface SKU may be viewed as a bridge SKU for which a plan may create demand, and for which the master planning module may create replenishment. Interface SKUs may be established at any level. An interface SKU is the breakpoint between allowing plans to generate replenishments for the distribution network and allowing master planning module to generate supplies based on constrained resource and material availability. At step 410, a user may create or update existing entities related to a supply chain, reference data such as locations, SKUs, interface SKUs, etc., and initial setup and updates as required.

At step 420, the plan is configured and prepared. Inputs for this step may include forecast, customer orders, stock on hand, in-transit shipments, current manufacturing schedules, demand to date, safety stock goals. This step may produce various outputs, including demand, stock on hand, capacity requirements, constraint settings, and demand prioritization. These outputs may be used as inputs in step 430. It should be understood that one may use one of several algorithms to execute a sequential run of plan and master planning. At step 430, inputs may be updated or imported, process operations may be set, and algorithms may be launched.

At step 430, the plan may also receive as inputs a plan for replenishments for each SKU through the end of the planning horizon. It may generate output for certain types of SKUs. It may also produce an input format for master planning such as planned arrivals.

At step 440, master planning is run to generate a master plan based on demands that exist at an interface SKU. The outgoing planned arrivals from an interface SKU that the plan has created in previous steps may be transferred into master planning demand at that interface SKU. The priority of this demand at the interface SKU may be the same as those for the forecast of the interface SKU. Upon completion, this demand may be stored in a database as forecast order. For a plan shipment at the interface SKU, there may be a forecast order at that interface SKU. Master planning may generate commanded shipments or planned orders for the interface SKUs, which the deployment process may use as supplies. Master planning may process certain types of SKUs within its network and create supplies to meet demands at certain types of interface SKUs.

At step 450, deployment, which is the first stage of the process following a completed run of master planning processes, may be executed using plans and/or deployment processes. A flag on an interface SKU may be used as a deployment signal to loop to those SKUs for the recommended shipments or planned orders. Plan deployment logic may be used for certain types of SKUs.

Master planning functions may be supported by time-phase actions to be taken within a determined planning period to meet demands. Distribution planning may be considered a scheduling tool that optimizes planning for distribution, based on factors such as net requirements by period, how long the inventory balance on hand will last, fair share rules, dynamic employment, and/or push logic, for example. The planning of production and orders may be used to ensure that orders are initiated or planned at the proper times in order to meet demand, and that capacity is adequate and appropriately utilized. The master planning module may accept prioritized focus and customer orders and develop an optimized production plan that respects these time as well as resources, materials, and constraints.

Operations of one embodiment of a master planning module of the present invention are now described in more detail. In editing supply orders, master planning may be implemented by processes that offer the following functions: increase/add the quantity of a supply order, decrease/delete the quantity of a supply order, move existing supply orders earlier, move existing supply orders later, move existing supply orders to a different supply method within a location, firm/unfirm supply orders, and move existing supply orders to a different supply method at a different location, for example. In performing these functions, the master planning processes may adapted to detect errors and report such errors to a user. For example, when increasing or adding the quantity to a supply order master planning may notify a user if there is any constraint violation found upstream.

In editing resource constraints, master planning may adjust a resource constraint setting, change the resource capacity calendar, and/or adjust the capacity of a resource. In editing demand orders, master planning may change the priority of a demand order or set a repair flag for the demand order.

The workflow of master planning may employ various alternative planning process approaches, including a plan extraction process approach, and plan review process approach.

Master planning modules according to the present invention may provide a user a first process to generate a plan. Preferably, this may include two types of planning processes—a regenerative process and a repair process. A user may use a regenerative process when there are significant changes to a reference data or as part of the planning process to employ certain policies. On a day-to-day basis, the user may use the repair process to effect certain changes to the plan such as a new inventory update, changes to scheduled supplies, updates to the demands, etc. The output of both the regenerative process and the repair process is a supply plan to meet demands

Using a plan extraction process, the user may run the plan process for all SKUs or a data selection of SKUs. In either case, the user may edit the plan for a smaller selection of SKUs. Using the plan extraction process, a plan for a data selection of SKUs may be extracted. The extracted plans may be stored in a cache. These extracted plans may also be used for editing and repair. The extracted plans may be saved under different names.

Once a plan is regenerated, a user may want to evaluate it for its “acceptability.” Users can gauge acceptability based on measurements like delivery performance, resource performance, or inventory performance. Based on these measurements planners may drill down to look why certain demand orders are late, partial or unmet, and/or how to get these orders to be met on time.

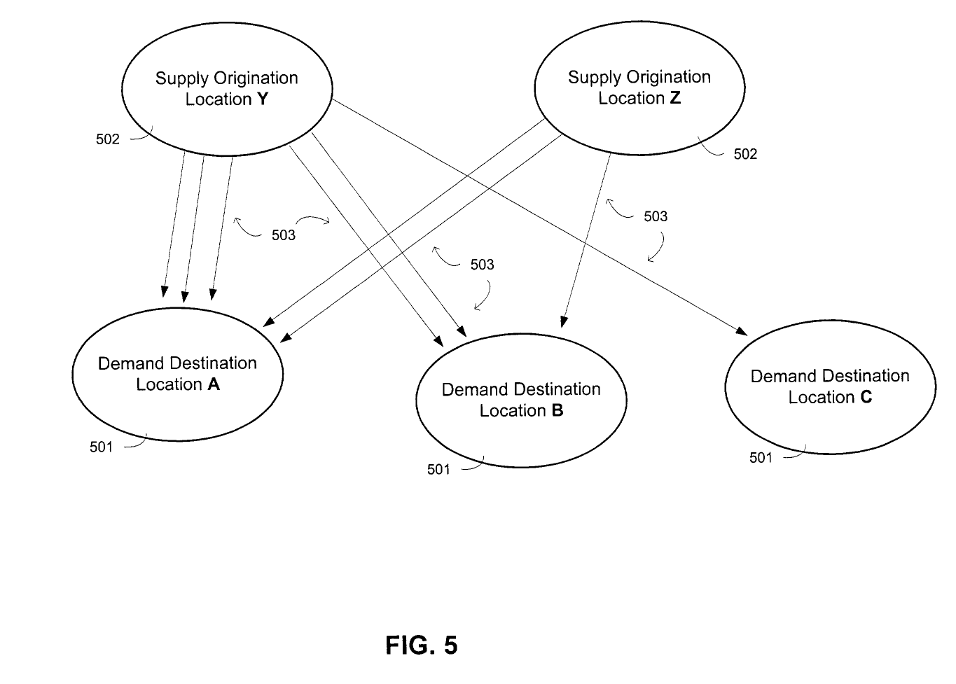

FIG. 5 is a representational diagram illustrating various shipping lane alternatives and supplier/buyer relationships that may occur between various locations in an example of a supply chain network. As seen in FIG. 5, it is commonplace for a multi-site supply and distribution chain of an enterprise to involve a plurality of demand destination locations 501 (e.g., manufacturing locations or inventory storehouses) which are dependent upon a plurality of supply origination locations 502 (e.g., manufacturing centers for certain supply items or distributor depots) to obtain various supply items as necessary. Understandably, these demand destination locations 501 could each produce the same SKU items through, for example, the same manufacturing processes, could use different processes for the same SKUs, or could produce completely different SKUs. The same can be said for the supply origination locations 502.

It is commonplace for enterprises having multi-site manufacturing, supply and distribution chains as depicted in FIG. 5 to encounter situations where the supply origination location 502, or supply point, of a particular item is remote from the demand destination location 501, or demand point. Thus, transportation services are necessarily interjected into the master planning problem of the supply chain because the transportation lead-time between a supply point and a demand point is variable.

Specifically, transportation carriers often require different lead times from trip to trip (separate trip schedulings 503 being designated in FIG. 5). Some carriers make certain trips direct one from the supply point to the demand point, while other carriers stop at a third location on their way to the demand location, resulting sometimes in undesirable delay. Thus, the lead times vary from one trip to another depending upon carrier and delivery date and time. For example, an otherwise feasible capacity plan generated by contemporary resources planning methodology may not be an adequate plan from a transportation perspective. This could be the case where a particular supply that was scheduled for arrival according to just in time (“JIT”) usage principles with certain transportation lead time assumptions may actually require a larger buffer during planning of the window of need in order to prevent the supply item from either being held in inventory or arriving late due to lead time variability.

To allow a master planning module according to the present invention to solve the vessel scheduling problem, it will be necessary for the module to have access to carrier transportation schedule information including when a trip scheduling starts and when it finishes. As described below, the trip scheduling algorithm employed will pick the closest early or on time trip scheduling as the schedule for transportation step.

The outcome from the trip scheduling algorithm will associate an out-handling process start time with the scheduled shipping date and an in-handling process finish time with a scheduled arrival date. Additionally, an indication as which carrier the algorithm has selected will be provided. The following example i will help clarify this aspect of embodiments of the invention.

Example i—The item demand at the supply point is a printer cartridge being produced in Tokyo. Demand for this item occurs at two independent locations in North America (LA and/or Boston). With a planned project start date of Jan. 1, 2001, it is predicted by the master planning module that three foreseeable supply orders will occur, namely:

1) Demand for 10 units at LA with a need date of Jan. 31, 2001

2) Demand for 10 units at Boston with a need date of Feb. 13, 2001

3) Demand for 10 units at Boston with a need date of Feb. 4, 2001

All three supply orders have an earliest delivery window of 3 days and a latest deliver window of 3 days. Transportation schedulings are available from this supply point by Carrier 1, Carrier 2, and Air, with shipping being preferred on Carrier 1 with Carrier 2 as an alternate. For this example, Air is the final option for all sourcing lanes and the lead time is fixed at 1 day.

Relevant transportation schedulings are listed below in Table i:

TABLE i

| Name | Source | Destination | Arrival Date | Departure Date |
|---|---|---|---|---|
| Carrier 1 | Tokyo | LA | Jan. 31, 2001 | Jan. 15, 2001 |
| Carrier 2 | Tokyo | LA | Jan. 31, 2001 | Jan. 10, 2001 |
| Carrier 1 | Tokyo | Boston | Feb. 12, 2001 | Jan. 15, 2001 |
| Carrier 2 | Tokyo | Boston | Feb. 13, 2001 | Jan. 15, 2001 |

In addressing order fulfillment, this algorithm employed by the master planning module will first address the demand for 10 units at LA with a need date of Jan. 31, 2001. Since the demand is required in LA on Jan. 31, 2001, this demand point will need a move supply method invocation to satisfy this demand. There are 3 possible move supply methods that could be associated with this demand, namely, move from Tokyo to LA via Carrier 1, move from Tokyo to LA via Carrier 2 and move from Tokyo to LA via Air. The first priority is to use Carrier 1. The master planning module will check the need date of the order against the arrival date of the vessels in the system.

In the above example the system may determine that the appropriate schedule to adopt for this order is Carrier 1, allowing the order to be scheduled for arrival in LA on Jan. 31, 2001.

The second demand order, requiring 10 units at Boston with a need date of Feb. 13, 2001, will also have 3 possible move supply methods associated with this demand, namely move from Tokyo to Boston via Carrier 1, move from Tokyo to Boston via Carrier 2 and move from Tokyo to Boston via Air. The first priority again is to use carrier 1, and this vessel scheduling process will check the need date of the order against the arrival date of the vessels in the system.

In the above example there is no arrive date scheduled on the primary supply method to arrive on Feb. 13, 2001. The system will then check to see if it can meet the demand early and schedule this order to arrive on carrier 1 on Feb. 12, 2001.

For the demand order requiring 10 units at Boston with a need date of Feb. 4, 2001, the system will operate as described above with the prior order, but see that there is no schedule applicable for both carrier supply methods to meet this demand on time or early on the first 2 supply methods. The system will then schedule this to demand to be air-shipped just in time to arrive Boston on the need date.

It is noted that there could be situations where different carriers with the same relative usage priorities attached could, of course, have the same arrival dates. In such cases, this vessel scheduling algorithm will attempt to find a feasible solution from both options and will not be deterministic in terms of which carrier to choose in that scenario.

The basic Broad Branch inquiry addressed by the vessel scheduling algorithm is whether there is an appropriate schedule to meet the demand on time or early one of the move supply methods. The associate Deep Tree logic the algorithm follows is described below in Table ii when it compares need dates to transportation schedules:

TABLE ii
Is there an appropriate schedule to meet the demand on time on the
primary move supply method?
Is there an appropriate schedule to meet the demand early on the primary
move supply method?
Is there an appropriate schedule to meet the demand on time on the
alternate move supply method?
Is there an appropriate schedule to meet the demand early on the alternate
move supply method?
Are there other alternates to try?
Is there an appropriate schedule to meet the demand late on the primary
move supply method?
Is there an appropriate schedule to meet the demand late on the alternate
move supply method(s)?

The algorithm utilized by the master planning module may have the logic that follows as steps 1-10 below when running the vessel scheduling problem of Example i above. Adopting the condition (Assume Step By=x days and MeetEarlyDur=2x days, and MeetLateDur=3x days; the Need Date is N; EarliestMeetDate=N−2x; and LatestMeetDate=N+3x), the algorithm proceeds by:

Step 1—Try the primary (highest priority) move supply method, see if N−2x<ScheduleArrival Time<N, if satisfied then done, else go to step 2.

Step 2—Try the alternate (next highest priority) move supply method, see if N−2x<ScheduleArrival Time<N, if satisfied then done, else go to step 3.

Step 3—Pick other alternate (next highest priority) go to step 2, when all supply methods had been tried, go to step 4.

Step 4—If Variable Load, Try N+3x as a New Need Date, go to step 1-3. If still not met, go to 10, else go to 5

Step 5—Pull the NeedDate of Demand Order to N−x as a New Need Date. go to step 1-3. if still not met go to step 6.

Step 6—Pull the NeedDate of Demand Order to N−2x as a New Need Date. go to step 1-3. if still not met go to step 7.

Step 7—Push the NeedDate of Demand Order to N+x as a New Need Date. go to step 1-3. if still not met go to step 8.

Step 8—Push the NeedDate of Demand Order to N+2x as a New Need Date. go to step 1-3. if still not met go to step 9.

Step 9—Push the NeedDate of Demand Order to N+3x as a New Need Date. go to step 1-3. if still not met go to step 10.

Step 10—Demand unmet, done!

If step 10 above is reached, then an error message is generated indicating that the supply order cannot be met. In this scenario, either the need dates of the master planning schedule would have to be adjusted or alternative supply sources would have to be identified.

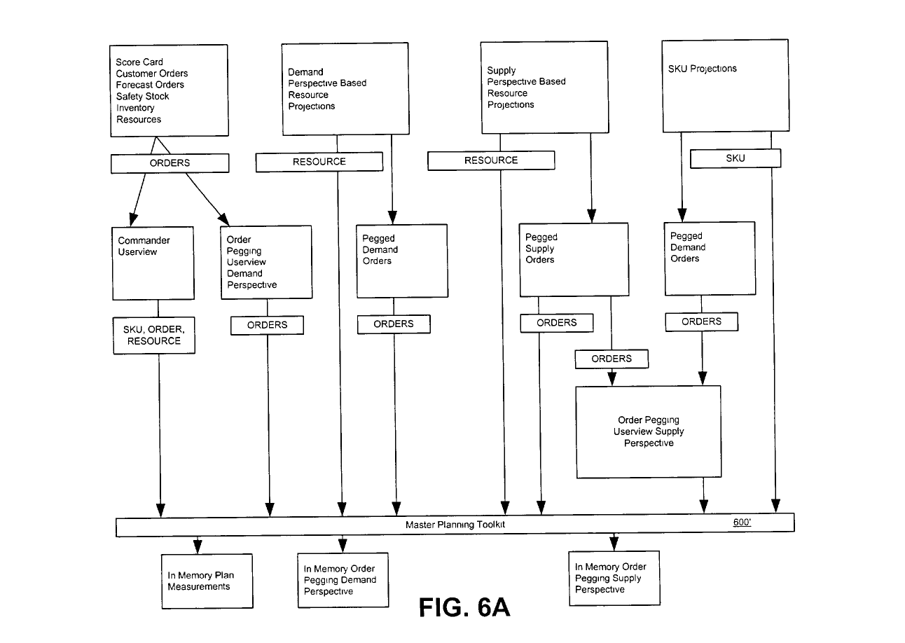

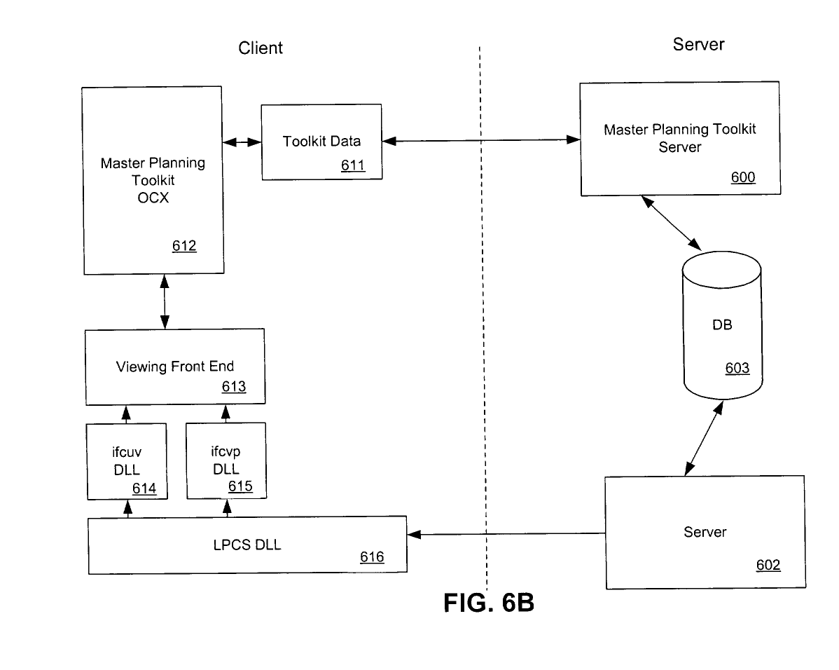

FIG. 6A shows tools that may be provided to assist a user in evaluating results of a plan execution. Such tools include: a commander userview, which displays business exceptions for a demand order; an order pegging userview, which displays supply orders that are responsible for meeting a demand order; a resource projections userview, which displays load due to various types of demand on a resource and an ability to drill into the actual demand orders that are causing the load; a resource projections userview with supply perspective, where loads are displayed based on supply types and further pegging provided into actual supply orders that cause the load; and/or a supply perspective order pegging userview, where the user may identify all demand orders that are pegged to a particular supply order.

After analysis has been performed and causes determined for the problems in plan performance, users may be allowed to edit the plan. One way to edit such a plan is with a master planning toolkit according to the present invention.

A master planning toolkit 600′ as shown in FIG. 6A may be provided to assist users in reviewing and/or editing plans. The toolkit 600′ may provide information in different contexts, such as a supply order context, demand order context, resource context, and SKU context. In the supply order context, a user may be allowed to edit attributes of a supply order after evaluating exceptions in a commander userview or supply orders in an order pegging userview (supply perspective) or in a userview for pegged supply orders causing load on a particular resource. In the demand order context, one may be allowed to edit one or more demand orders. Such demand orders may be reviewed, for example, in the commander userview, or order pegging userview (demand perspective), or a userview for pegged demand orders that are part of a SKU projection. In the resource context, a user may be allowed to edit resource settings or load on resources based on evaluation of the resource-loading pattern in resource projections. Such projections may be displayed on a supply or demand perspective. In the SKU context, users may evaluate SKU problems based on SKU projections or inventory exceptions.

A repair process may be invoked by a user after performing one or more edits. Upon invocation of the repair process, a repair algorithm may be executed. The repair algorithm may be used to repair material exceptions, resource exceptions, and demand status exceptions generated due to the edit and validate. The repair algorithm may run on an algorithm data view and transform updated algorithm objects into a demand data view or a persistence cache. A user may review the repaired plan after the repair process. After repair and review of the plan, a user may publish the plan, for example, to relational database.

FIG. 6B shows a representational diagram showing an environment in which a master planning toolkit of the present invention may be used. A master planning toolkit may be executed in client/server architecture. On the server side, there are servers 600 and 602 and a database 603. The server 600 has a master planning toolkit and is connected to the database 603 and a toolkit data 611 in the client. The server 602 is connected to the database 603 and sends a message to a dynamic linking library (“DLL”) (616) in the client.

On the client side, there are the toolkit data 611, master planning toolkit OCX (i.e. OLE (object linking and embedding) custom control), a viewing front end 613, and various digital linking libraries, ifcuv DLL (614), ifcvp DLL (615), and LPCS DLL (616). They are also connected to each other via a network and are capable of communicating with each other. One or ordinary skill in the art would recognize that the present invention is not dependent on a specific architecture, and that the client/server architecture of FIG. 6B given as an example.

The basic layout and general features of the invention having thus been introduced, one of ordinary skill in the art will readily appreciate that master planning modules of the present invention may handle various types of user cases. These cases include user cases arising from adjusting supply orders, demand orders, and resource constraints. These user cases are now described in detail.

Supply orders may be adjusted by (1) increasing/adding the quantity of a supply order; (2) decreasing/deleting the quantity of a supply order; (3) moving existing supply orders earlier; (4) moving existing supply orders later; (5) moving existing supply orders to a different supply method within a location; (6) moving existing supply order to a different supply method at a different location; and/or (7) firming/unfirming supply orders. These supply order adjustment operations are now described in detail including their validation and repair processes.

When a user increase or add a supply order, master planning processes may create new dependent demands and upstream supply. An upstream supply includes those that are towards raw materials and/or suppliers within the supply chain. If user wants the additional supply to be pegged to demands, the user may then specify demands to be repaired. The steps involved in a validation routine may include: (1) record changes to the added/edited order in a log; (2) transform the changed order into an algorithm model; (3) add/update dependent demand order using the resource capacity as a constraint; and (4) generate any material requirements and resource capacity exceptions.

During a repair routine, a deep-tree algorithm (“Deep Tree”), which is described in detail below, may be used to search supply for each dependent demand order. In so doing, additional supply orders and dependent demands may be created for the materials. Any material/capacity constraint exception may be generated upstream. If the order is firm, it will be added. If the order is not firm, it will not be added.

When a user decreases and/or deletes the quantity of a supply order, master planning processes may repair both upstream (i.e., toward raw materials and/or suppliers within the supply chain) and downstream (i.e., toward finished good and/or customers within the supply chain). If a downstream firm supply is affected by the decrease/delete action, the user may be notified.

In a validation rountine, changes to the reduced/deleted order may be recorded in a log. The changed order may be transformed into an algorithm model. If the order can be reduced/deleted, any demands affected by the reduced/deleted supply may be displayed to the user. The dependent demands for the reduced/deleted supply may be updated/deleted. Further, excess material, which may be reduced in repair, may be displayed to the user.

In a repair routine of the master planning processes, upstream supply/pegging for each dependent demand order may be reduced. Demands affected by the reduced/deleted supply may or may not be met. Any material/capacity exceptions may be generated. Also any demand status change exceptions may be generated.

If a user moves existing supply orders earlier, master planning processes may maintain previous demand order pegs to the supply order. In a validation routine, master planning may: (1) record changes to the moved order in a log; (2) update demand and demand-need date; (3) display any material exceptions to meet dependent demands for the moved date; (4) update resource loads for the earlier buckets; and (5) display any capacity exceptions to load the resources earlier. In a repair routine, master planning processes may: (1) reduce upstream from the supply order and then delete the later supply order; (2) constrain the order against resource capacity; (3) use Deep Tree algorithm to search supply for each dependent demand order; (4) If the moved order is firm, retain the order with the moved date irrespective of the material and capacity exceptions and re-peg supply order using the previous order pegs; (5) If the moved order is not firm, and if there are no capacity and material constraints, re-peg demands to the moved supply order; and (6) If the moved order is not firm, and if there are capacity and material constraints, delete the order, re-plan the pegged demands to create the required supplies, and generate any material and capacity exceptions in meeting demands.

When a user moves existing supply orders later, master planning may maintain previous supply order pegs into the supply order. In a validation routine, master planning processes may: (1) record changes to the moved order in a log; (2) update the demand and demand-need date; (3) update resource loads for the later buckets; and (4) display any capacity exceptions to load the resources later. In a repair routine, master planning processes may: (1) constrain the order against resource capacity; (2) if the moved order is firm, retain the order with the moved date irrespective of the capacity exception and re-peg supply order using the previous order pegs; (3) if the moved order is not firm, and if there are no capacity constraints, re-peg the demands to the moved supply order; and (4) if the moved order is not firm, and if there are capacity constraints, delete the order, re-plan the pegged demands to create the required supplies, and generate any material and capacity exceptions in meeting these demands.

If a user moves existing supply orders to a different supply method within a location, master planning processes may maintain previous demand order pegs to the supply order. New requirements may be generated using the new supply method, and old supply method requirements may be deleted. A scheduled date may be maintained, while the start date may be re-calculated based on the change of the lead-time. In a validation routine, master planning processes may: (1) record changes to the moved order in a log; (2) delete the dependent demands and create new dependent demands as per the new supply method BOM (“bill of materials”); (3) delete resource loads for the current supply method resources; (4) create new resource loads for the new supply method resources; and (5) display any capacity exceptions and material requirements for the new supply method. In the repair routine, master planning processes may: (1) constrain the order against new resources capacity; (2) if the moved order is firm, retain the order on the new supply method irrespective of the capacity exceptions; (3) if the order is not firm, and if there are capacity constraints, delete the order, re-plan the independent demands pegged to the supply order at the original location, and generate any material and capacity exceptions; and (4) if the order passes the capacity checks, check the order for material for all the dependent demands, using Deep Tree to search supply for each dependent demand order.

If a user moves an existing supply order to a different supply method at a different location, master planning processes may maintain previous demand order pegs to the supply order. New requirements may be generated using the new supply method, and old supply method requirements may be deleted. In a validation routine, master planning processes may: (1) record changes to the moved order in a log; (2) delete the dependent demands and create new dependent demands at the new location; (3) delete resource loads for the current location resources; (4) create new resource loads for the new location resources; and (5) display any capacity exceptions and material requirements for the new location. In a repair routine, master planning processes may: (1) constrain the order against new location resources capacity; (2) if the moved order is firm, retain the order at the new location irrespective of the capacity exceptions; (3) if the order is not firm, and if there are capacity constraints, delete the order; and (4) if the order passes the capacity checks, check material for all the dependent demands, using Deep Tree to search supply for each dependent demand order, re-plan the independent demands pegged to the supply order at the original location, and generate any material and capacity exceptions in meeting these independent demands.

Finally, if a user firms or unfirms supply orders, the master planning module may not change or adjust supply orders that are made after either repair or regeneration is run. Supply orders that were previously firm that are unfirmed may be deleted or adjusted after either repair or regeneration is run. In a validation routine initiated by a master planning module according to an embodiment of the present invention, a firm flag chance may first be recorded in a change log followed by transforming the flag change into an algorithm model. In an associated repair routine, the master planning module's processes may: (1) if an order firmed, make no changes; and (2) if the order was unfirmed, delete the order if there are material and capacity exceptions for the original firm order, re-plan independent demands affected by the deletion of the unfirm order using Deep Tree to search supply for each independent demand order, and generate any material and capacity exception in meeting these demands.

A user may adjust a demand order by changing for example a calculated priority of the demand order. Through editing the priority, user can simulate the order preemption functionality. Master planning may record the priority change in a log. The pegging from the demand order to its supply orders may be removed, using Deep Tree to search supply for the independent demand order.

A user may also adjust resource constraints by adjusting factors such as the capacity of a resource, resource constraint setting, resource capacity calendar time, and/or resource load time for a supply order.

For example, when a user adjusts capacity of a resource constraint setting, the master planning module may employ a process which records the change of the constraint setting in a log, transform the constraint setting, and checks for the resource constraint violations. If there are constraint violations, this master planning process can then display exception messages to the user about the violations. In a subsequent repair routine, capacity violations on the resource for each bucket may be checked. If there are hard constraint violations, then non-firm supply orders in the bucket may be deleted (both up and down stream) using Deep Tree to search supply for unmet/met-late/partially-met independent demand orders. If there are soft constraint violations, then exceptions may be generated. If the adjustment results in capacity increase, any earlier constraint violation exceptions corresponding to that bucket may be deleted.

When a user changes the resource capacity calendar name, the master planning module may reemploy a process that follows the new calendar that has been assigned to the resource when planning supplies to meet demand. More specifically, in a validation routine, master planning may record the change of the calendar name in a log, set up the resource capacity vector using the new calendar, and check for the resource constraint violations. If there are constraint violations, appropriate exception messages are generated. In a repair process, capacity violations on the resource for each bucket may be checked. If there are hard constraint violations, then non-firm supply orders in the bucket may be deleted (both up and down stream) using Deep Tree to search supply for unmet/met-late/partially-met independent demand orders. If there are soft constraint violations, then exceptions may be generated. If the adjustment results in capacity increase, any earlier constraint violation exceptions corresponding to that bucket may be deleted.

Finally, if a user moves resource load time for a supply order, an appropriate process implemented by the master planning module may check for local feasibility among the resources in the supply method before running repair for the rest of the item's supply chain. In a validation routine, the log edits on the supply order may be transformed. The new supply order may be created on the same supply method. It may further update and/or create appropriate resource load details, generate any resource constraint violations, and reduce appropriate dependent demands and create new dependent demands for the new supply order. In a repair routine, capacity violations on the resource for each bucket may be checked. If there are hard constraint violations, then non-firm supply orders in the bucket may be deleted (both up and down stream) using Deep Tree to search supply for unmet/met late/partially met independent demand orders. If there are soft constraint violations, then exceptions may be generated.

In order to support a complex manufacturing environment, a planning system preferably understands when the finite capacity tool has scheduled a supply order differently than what was originally suggested by the planning tool. In one embodiment of the present invention, all high priority ways of supplying SKUs are modeled and then prioritized. As such, how the capacity of the resources and routes are utilized may not be the way that capacity and routes are scheduled. However, it is preferable for master planning to understand the output of the scheduling tool. If a supply order is scheduled using different resources, it is desirable for master planning to receive that information. This ensures that the resources that master planning had planned to utilize are freed up to make other supply orders, in that the capacity on the resources that are used get consumed.

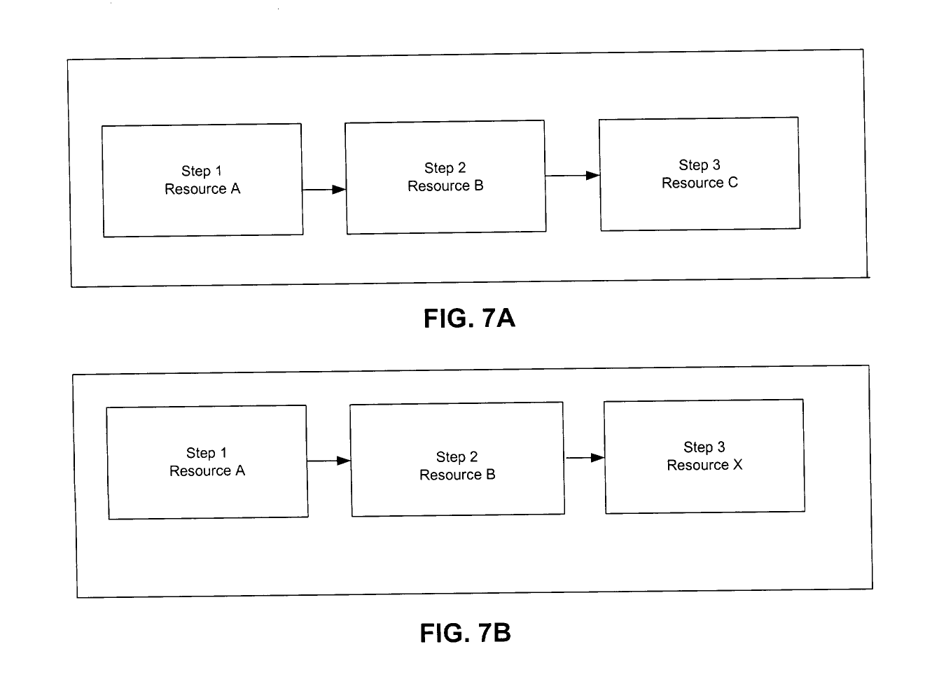

Master planning may respect the resources and routes used by the scheduling system without the setup of actual routes for the supply order. Since this type of information would typically exist for supply orders that are scheduled by the scheduling system, data may be imported from scheduled receipts, for example. For example, as shown in FIG. 7A, a finished good item may be produced using resources A, B, and C in that order. Master planning may place all the load for a supply order of the item on these resources A, B, C and pass the information to the scheduling system. If the scheduling system finds that it cannot utilize resources as master planning had suggested, it may schedule the supply order on a different route such as one shown in FIG. 7B, namely resources A, B, and X. In response, master planning may notice that the capacity it planned to use supply order on resource C is available, in that the capacity on resource X is being utilized and no longer available.

Aggregate SKU Planning

When planning production of multiple SKUs, there may be a need to group the production of certain SKUs together. This may be due to shared materials, resources or capacities during production. Such groups of SKUs may be referred to as item families or product families, and are seen in many industries from apparel to consumer products.

An aggregate SKU planning of the present invention is a feature that allows users to plan for item or product families. In the aggregate SKU planning, SKUs are defined as the lower-level SKUs within the aggregate SKU planning setup. An aggregate SKU represents is a SKU that represents the aggregate of at least two SKUs. An aggregate SKU may be a virtual item, i.e., an item that is not physically kept in an inventory.

A lower-level SKU is a SKU that is part of a product family, or aggregate SKU. A lower-level SKU itself may be a logical SKU on it own. Factors, such as how and when a lower-level SKU is replenished may depend on other SKUs that are part of the same aggregate SKU. Further, lower-level SKUs are preferably the lowest level SKUs within the model setup. These SKUs may not appear as source SKUs in any sourcing method, subordinates in a BOM setup, or in any imported dependent demand records. If a lower-level SKU is either a source in the move or a subordinate in a BOM, an exception may be reached into a database, and the lot for lot order policy may be used for this SKU.

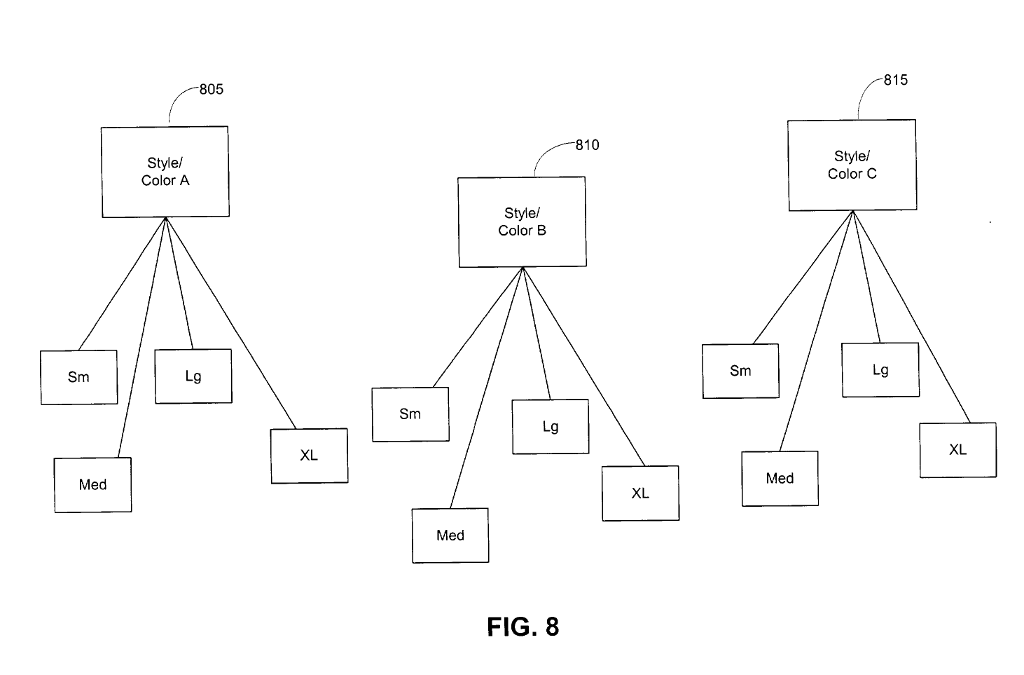

Planning based on aggregate SKUs is explained using an example. Within the apparel industry, for example, it is common for users to define SKUs at the style/color/size level. Typically, this is the level at which on-hand inventory is maintained and customer orders are received. When planning supply, a user may, for example, produce one style/color together, using the same production method and material for all sizes. In the example shown in FIG. 8, there are three style/color combinations (i.e., aggregate SKUs), namely style/color A (805), style/color B (810), and style/color C (815). For each style/color, there are four sizes, small (“sm”), medium (“med”), large (“lg”), and extra-large (“xl”) as depicted. There are three supply methods for replenishing supply (or, alternatively, materials needed to replenish supply) which are designated in the following examples as make X, make Y, and make Z.

Table 1 shows an independent demand (i.e. forecast and customer orders) placed for individual sizes of the style/color. Specifically, it shows quantity needed and calculated priority for each style/color/size.

TABLE 1

| Style/Color | Size | Quantity Needed | Calc. Priority |
|---|---|---|---|
| A | Sm | 500 | 63 |
| A | Med | 100 | 24 |
| A | Lg | 300 | 52 |
| A | XL | 400 | 64 |
| Total for A | | 1300 | |
| B | Sm | 200 | 60 |
| B | Med | 250 | 21 |
| B | Lg | 300 | 50 |
| B | XL | 500 | 53 |
| Total for B | | 1250 | |
| C | Sm | 100 | 35 |
| C | Med | 100 | 10 |
| C | Lg | 100 | 12 |
| C | XL | 200 | 47 |
| Total for C | | 500 | |

Table 2 shows one way of supplying each style/color/size demand. The plan shown in Table 2 has some inefficiencies—for example, for each style/color (A, B, and/or C), three materials (X, Y, and Z) must be available. It is more efficient to use a single supply method (or material) for one style/color.

TABLE 2

| | | Quantity | Calc. | Quantity | Supply |
|---|---|---|---|---|---|
| Style/Color | Size | Needed | Priority | Scheduled | Method Used: |
| A | | 1300 | | 1300 | |
| A | Sm | 500 | 63 | 500 | Make Z |
| A | Med | 100 | 24 | 100 | Make X |
| A | Lg | 300 | 52 | 300 | Make Y |
| A | XL | 400 | 64 | 400 | Make Z |
| B | | 1250 | | 1250 | |
| B | Sm | 200 | 60 | 200 | Make Z |
| B | Med | 250 | 21 | 250 | Make X |
| B | Lg | 300 | 50 | 300 | Make Y |
| B | XL | 500 | 53 | 500 | Make Z |
| C | | 500 | | 500 | |
| C | Sm | 100 | 35 | 100 | Make X |
| C | Med | 100 | 10 | 100 | Make X |
| C | Lg | 100 | 12 | 100 | Make X |
| C | XL | 200 | 47 | 200 | Make Y |

To achieve the desired result, a user may set up relationships among all Aggregate SKUs (style/colors) and lower-level SKUs (style/color/size). A BOM may be used for this purpose. User may also specify an aggregate horizon, i.e., a time period that the lower-level SKUs' demands are aggregated into one supply order at the aggregate SKU. When several demands exist within the aggregate, all with different need dates, the need date of the aggregate SKU supply order will be the earliest of all of the demands within that horizon that are part of that aggregate SKU. If each demand order within the aggregate horizon for an aggregate SKU has a different meet late duration, the shortest (or minimum) meet late duration may be used for aggregate SKU's supply order.

Using aggregate SKU planning, dependant demands that are placed on an aggregate SKU may be aggregated over a user-defined span of time, creating a single supply order for that aggregate SKU to satisfy all of the lower-level SKUs' (i.e., dependant) demands as shown in Table 3. In Table 3, style/color A, style/color B and style/color C each uses a single material, namely X, Y, and Z, respectively. A user may define a priority (or preference) among supply methods for each style/color.

TABLE 3

| | | Quantity | Quantity | Supply Method |
|---|---|---|---|---|
| Style/Color | Size | Needed | Scheduled | Used: |
| A | | 1300 | 1300 | Make X |
| A | Sm | 500 | 500 | Make X |
| A | Med | 100 | 100 | Make X |
| A | Lg | 300 | 300 | Make X |
| A | XL | 400 | 400 | Make X |
| B | | 1250 | 1250 | Make Y |
| B | Sm | 200 | 200 | Make Y |
| B | Med | 250 | 250 | Make Y |
| B | Lg | 300 | 300 | Make Y |
| B | XL | 500 | 500 | Make Y |
| C | | 500 | 500 | Make Z |
| C | Sm | 100 | 100 | Make Z |
| C | Med | 100 | 100 | Make Z |
| C | Lg | 100 | 100 | Make Z |
| C | XL | 200 | 200 | Make Z |

When it is infeasible to get all the supply from one supply method, and it is permissible to use more than one supply method to satisfy an aggregate SKU demand, more than one supply method may be used. An assignment of supply methods may be based on a priority assigned to each style/color/size and priorities among supply methods within each style, for example.

Demands of aggregate SKUs may be either dependent demands arising from independent demands for the lower-level SKUs, or they can be independent demands for the aggregate SKUs themselves. If there is any excess supply, such supply may be distributed among artificial demands for the lower-level SKUs.

There may be at least two cases where the supply order that has been generated to meet the aggregate demand order is different from the sum of the demands of the lower-level SKUs. These cases occur, when supply is greater than demand due to lot sizes or when demand is greater than supply due to capacity constraints. Each case is described below in detail.

If lot sizes are applied to supply methods of aggregate SKUs, more supply may exist than the lower level SKUs' demands. For example, the following lot sizes may be set on the supply methods at the style/color (i.e., aggregate SKU) level: A (1500), B (1750), and C (500).

Where there is an extra supply, a user may define how the extra supply should be used. For example, such extra supply may be spread evenly, proportionally, or based on the Aggregate SKU profile over the lower-level SKUs.

When there is more supply at the aggregate SKU level than the demands of the lower-level SKUs, a new type of stock order may be created. The use of the new stock order type may ensure that all supply that is created in the supply chain is pegged to a lower-level demand order. In addition, planned supplies may be created to represent the supply that is planned to be made at the lower-level SKUs. Such planned supplies ensure that the projected inventory for those SKUs is accurate. The type of planned supply that is created may depend on a set up—for example, if a BOM (or a make supply method feature) is used to define the relationship between the aggregate and lower-level SKUs, planned orders may be created. If sourcing (or a move) is used, recommended shipments may be created.

If the extra supply is to be spread evenly, based on the scheduled supply of the aggregate SKU, it is distributed evenly to the lower-level SKUs as shown, for example, in Table 4.

TABLE 4

| | | | | | Supply |
|---|---|---|---|---|---|
| | | Quantity | Extra | Quantity | Method |
| Style/Color | Size | Needed | Supply | Scheduled | Used: |
| A | | 1300 | 200 | 1500 | Make X |
| A | Sm | 500 | 50 | 550 | Make X |
| A | Med | 100 | 50 | 150 | Make X |
| A | Lg | 300 | 50 | 350 | Make X |
| A | XL | 400 | 50 | 450 | Make X |
| B | | 1250 | 500 | 1750 | Make Y |
| B | Sm | 200 | 125 | 325 | Make Y |
| B | Med | 250 | 125 | 375 | Make Y |
| B | Lg | 300 | 125 | 425 | Make Y |
| B | XL | 500 | 125 | 625 | Make Y |
| C | | 500 | 0 | 500 | Make Z |
| C | Sm | 100 | 0 | 100 | Make Z |
| C | Med | 100 | 0 | 100 | Make Z |
| C | Lg | 100 | 0 | 100 | Make Z |
| C | XL | 200 | 0 | 200 | Make Z |

The extra supply may be spread proportionally using the percentage of each lower-level SKU that contributed to the original Quantity Needed of the aggregate SKUs (i.e. column 3 of Table 5). That percentage may then be applied to the extra supply of the aggregate SKUs to produce the lower-level SKU's scheduled supplies as shown in Table 5.

TABLE 5

| | | | | | | Supply |
|---|---|---|---|---|---|---|
| | | Quantity | | Extra | Quantity | Method |
| Style/Color | Size | Needed | % | Supply | Scheduled | Used: |
| A | | 1300 | | 200 | 1500 | Make X |
| A | Sm | 500 | 38 | 76 | 576 | Make X |
| A | Med | 100 | 8 | 16 | 116 | Make X |
| A | Lg | 300 | 23 | 46 | 346 | Make X |
| A | XL | 400 | 31 | 62 | 462 | Make X |
| B | | 1250 | | 500 | 1750 | Make Y |
| B | Sm | 200 | 16 | 80 | 280 | Make Y |
| B | Med | 250 | 20 | 100 | 350 | Make Y |
| B | Lg | 300 | 24 | 120 | 420 | Make Y |
| B | XL | 500 | 40 | 200 | 700 | Make Y |
| C | | 500 | | 0 | 500 | Make Z |
| C | Sm | 100 | | 0 | 100 | Make Z |
| C | Med | 100 | | 0 | 100 | Make Z |
| C | Lg | 100 | | 0 | 100 | Make Z |
| C | XL | 200 | | 0 | 200 | Make Z |

The extra supply may be spread based on an aggregate SKU profile. The aggregate SKU profile is a percentage split that is set up by the user, defining what percentage of the aggregate SKUs typically makes up each of the lower-level SKUs. Since the demands for the aggregate SKUs can be either dependent demands arising from independent demands of the lower-level SKUs, or independent demands for the aggregate SKUs themselves, the aggregate SKU profile can be used to spread excess supply to the lower-level SKUs. The excess supply will be the difference between the total supply for the aggregate SKUs in the aggregation period and the total demand (dependent+independent) in the same aggregation period. This excess may be pegged to lower-level SKUs, according to the aggregate SKU profile.

For example, a style/color D may have following aggregate SKU profile based on sizes—small (20%), medium (35%), large (30%), and extra-large (15%). Table 6 shows how an extra supply of 200 may be spread proportionally among lower-level SKUs of the style/color D based on the aggregate SKU profile.

TABLE 6

| | | Quantity | Extra | Quantity | Supply |
|---|---|---|---|---|---|
| Style/Color | Size | Needed | Supply | Scheduled | Method Used: |
| D | | 1000 | 200 | 1200 | Make X |
| D | Sm | 500 | 40 | 540 | Make X |
| D | Med | 200 | 70 | 270 | Make X |
| D | Lg | 300 | 60 | 360 | Make X |
| D | XL | 0 | 30 | 30 | Make X |

The second case occurs when the demand is greater than supply. If capacity is constrained, there may not be enough available supply of the aggregate SKUs to satisfy all of the lower-level SKUs' demands. As an example, the aggregate SKUs, style/color A, B, and C may have only 1000, 1000, 500 supplies available, respectively, as shown in Table 7. A user may specify how available supply may be used to satisfy the lower-level SKUs' demands.

TABLE 7

| | | Quantity | Calc. | Quantity | Supply |
|---|---|---|---|---|---|
| Style/Color | Size | Needed | Priority | Scheduled | Method Used: |
| A | | 1300 | | 1000 | Make X |
| A | Sm | 500 | 63 | 500 | Make X |
| A | Med | 100 | 24 | 100 | Make X |
| A | Lg | 300 | 52 | 300 | Make X |
| A | XL | 400 | 64 | 100 | Make X |
| B | | 1250 | | 1000 | Make Y |
| B | Sm | 200 | 60 | 0 | Make Y |
| B | Med | 250 | 21 | 250 | Make Y |
| B | Lg | 300 | 50 | 300 | Make Y |
| B | XL | 500 | 53 | 450 | Make Y |
| C | | 500 | | 500 | Make Z |
| C | Sm | 100 | 35 | 100 | Make Z |
| C | Med | 100 | 10 | 100 | Make Z |
| C | Lg | 100 | 12 | 100 | Make Z |
| C | XL | 200 | 47 | 200 | Make Z |

It is possible that some of the calculated priorities are the same for more than one demand order. If this happens and there is not enough supply to cover all of the demands with the same calculated priority, master planning may proportionally split the remaining supply among the demands that have the same calculated priority, as shown in Table 8.

TABLE 8

| | | | | | | Supply |
|---|---|---|---|---|---|---|
| | | Quantity | Calc. | | Quantity | Method |
| Style/Color | Size | Needed | Priority | | Scheduled | Used: |
| D | | 1350 | | | 1000 | Make Z |
| D | Sm | 100 | 35 | 33% | 83 | Make Z |
| | | | | applied | | |
| | | | | to 250 | | |
| D | Sm | 200 | 35 | 67% | 167 | Make Z |
| | | | | applied | | |
| | | | | to 250 | | |
| D | Med | 100 | 10 | | 100 | Make Z |
| D | Med | 250 | 10 | | 250 | Make Z |
| D | Lg | 100 | 12 | | 100 | Make Z |
| D | Lg | 300 | 12 | | 300 | Make Z |
| D | XL | 200 | 47 | | 0 | Make Z |
| D | XL | 100 | 47 | | 0 | Make Z |

If the user chooses to spread the undersupply evenly, master planning may take the difference of the needed supply and the scheduled supply of the aggregate SKU (Style/Color) and evenly distribute it to the lower-level SKUs (Style/Color/Size). The undersupply may only be spread to those lower-level SKUs with Need Quantities in the specified aggregate horizon. Table 9 shows one example in which the undersupply is spread evenly.

TABLE 9

| | | | | | Supply |
|---|---|---|---|---|---|
| | | Quantity | | Quantity | Method |
| Style/Color | Size | Needed | Undersupply | Scheduled | Used: |
| A | | 1300 | 300 | 1000 | Make X |
| A | Sm | 500 | 75 | 425 | Make X |
| A | Med | 100 | 75 | 25 | Make X |
| A | Lg | 300 | 75 | 225 | Make X |
| A | XL | 400 | 75 | 325 | Make X |
| B | | 1250 | 250 | 1000 | Make Y |
| B | Sm | 200 | 62.5 | 137.5 | Make Y |
| B | Med | 250 | 62.5 | 187.5 | Make Y |
| B | Lg | 300 | 62.5 | 237.5 | Make Y |
| B | XL | 500 | 62.5 | 437.5 | Make Y |
| C | | 500 | | 500 | Make Z |
| C | Sm | 100 | | 100 | Make Z |
| C | Med | 100 | | 100 | Make Z |
| C | Lg | 100 | | 100 | Make Z |
| C | XL | 200 | | 200 | Make Z |

It is possible that the undersupply calculated for a lower-level SKU is greater than that SKUs' original need. In this case, the scheduled quantity for that lower-level SKU may be set to 0, and the remaining undersupply may be spread evenly among the other Lower Level SKUs, as shown, for example, in Table 10.

TABLE 10

| | | Quantity | | Recalculated | Quantity |
|---|---|---|---|---|---|
| Style/Color | Size | Needed | Undersupply | Undersupply | Scheduled |
| D | | 1000 | 700 | 700 | 300 |
| D | Sm | 200 | 175 | 200 | 0 |
| D | Med | 250 | 175 | 200 | 50 |
| D | Lg | 450 | 175 | 200 | 250 |
| D | XL | 100 | 175 | 100 | 0 |

If the user chooses to spread the undersupply proportionally, master planning may calculate the percentage that each lower-level SKU (Style/Color/Size) contributes to the original Need Quantity of the aggregate SKU (Style/Color). That percentage may then be applied to the difference between the Needed Quantity and the Scheduled Quantity of the aggregate SKU to produce the lower-level SKUs' undersupply amounts. Those undersupply amounts may be subtracted from each lower-level SKUs' original needed quantity. The undersupply may only be spread to those lower-level SKUs with Need Quantities in the specified aggregate horizon. Table 11 shows an output in a case in which undersupply is spread proportionally.

TABLE 11

| | | | | | | Supply |
|---|---|---|---|---|---|---|
| Style/ | | Quantity | | | Quantity | Method |
| Color | Size | Needed | % | Undersupply | Scheduled | Used: |
| A | | 1300 | | 300 | 1000 | Make X |
| A | Sm | 500 | 38 | 114 | 386 | Make X |
| A | Med | 100 | 8 | 24 | 76 | Make X |
| A | Lg | 300 | 23 | 69 | 231 | Make X |
| A | XL | 400 | 31 | 93 | 307 | Make X |
| B | | 1250 | | 250 | 1000 | Make Y |
| B | Sm | 200 | 16 | 40 | 160 | Make Y |
| B | Med | 250 | 20 | 50 | 200 | Make Y |
| B | Lg | 300 | 24 | 60 | 240 | Make Y |
| B | XL | 500 | 40 | 100 | 400 | Make Y |
| C | | 500 | 500 | Make Z | | |
| C | Sm | 100 | 100 | Make Z | | |
| C | Med | 100 | 100 | Make Z | | |
| C | Lg | 100 | 100 | Make Z | | |
| C | XL | 200 | 200 | Make Z | | |

Lot sizes (such as minimums, increments, and maximums) may be set at either the aggregate SKU or the lower-level SKUs. When set at the aggregate SKU, but not the lower-level SKUs, an excess supply situation may occur, causing the system to have to spread the excess.

If lot sizes are set at the lower-level SKUs, then it is possible that the supply scheduled at the aggregate SKU and then distributed to the lower-level SKU evenly, proportionally, by profile, or by calculated priority may not follow the lot size settings. In general, the Need Quantities of new planned supply orders preferably respects the minimum, maximum, and increment settings, but the Scheduled Quantities may not.

If an aggregate SKU demand cannot be met on one supply method, and assuming that the use has determined that it is acceptable to get supply from more than one supply method, then the demand orders from the lower-level SKUs may or may not follow a supply-method profile. Table 12 is an example of following the supply-method profile, while Table 13 is an example of not following the supply method profile.

TABLE 12

| | | Quantity | % | Quantity | Supply |
|---|---|---|---|---|---|
| Style/Color | Size | Needed | Profile | Scheduled | Method Used: |
| A | | 1500 | 67 | 1000 | Make X |
| A | Sm | 500 | | 334 | Make X |
| A | Med | 200 | | 132 | Make X |
| A | Lg | 400 | | 267 | Make X |
| A | XL | 400 | | 267 | Make X |
| A | | | 33 | 500 | Make Y |
| A | Sm | | | 166 | Make Y |
| A | Med | | | 68 | Make Y |
| A | Lg | | | 133 | Make Y |
| A | XL | | | 133 | Make Y |

TABLE 13

| | | Quantity | Calc. | Quantity | Supply Method |
|---|---|---|---|---|---|
| Style/Color | Size | Needed | Priority | Scheduled | Used: |
| A | | 1500 | | 1000 | Make X |
| A | Sm | 500 | 63 | 400 | Make X |
| A | Med | 200 | 24 | 200 | Make X |
| A | Lg | 400 | 52 | 400 | Make X |
| A | XL | 400 | 64 | 0 | Make X |
| A | | | | 500 | Make Y |
| A | Sm | | | 100 | Make Y |
| A | Med | | | 0 | Make Y |
| A | Lg | | | 0 | Make Y |
| A | XL | | | 400 | Make Y |

Various functions may be used in aggregate SKU planning. Functions may be used to: (1) define what SKUs are part of the same aggregate SKUs; (2) net inventory at the lower-level SKU; (3) aggregate demand order at aggregate SKU; (4) implement a user defined time bucket for the aggregation of the demand orders; (5) make visible the lower-level SKUs' requirements at any point within the network; (6) provide a switch on the SKU to determine whether it is acceptable to get supply from only one supply method or not; (7) implement logic that determines what to do with the supply order at the aggregate SKU when it does not match the total of the lower-level SKUs associated with it; (8) if the aggregate supply order at the aggregate SKU is greater than the total of the lower-level SKUs' demands, spread the extra supply either evenly, proportionally, or based on aggregate SKU profile; (9) if the aggregate supply order at the aggregate SKU is less than the total of the lower-level SKUs' demands, spread the available order by calculated priority, proportionately, or evenly; (10) if an aggregate SKU or aggregate supply order is supplied by more than one supply method, split the lower-level SKUs' demand element such that each is spread over the supply methods in the same ratio that the supply methods are satisfying the demand; (11) write an exception at aggregate SKU to inform that extra supply has been created; and (12) write an exception at the lower-level SKU informing that demand is not to the met due to not enough supply at the aggregate SKU. Those skilled in the art would appreciate that these functions are provided as examples and the present invention is not limited to implementations of these specific functions.

Next, algorithms used in one embodiment of aggregate SKU planning are described.

Table 14 shows one way of incorporating aggregation logic in a broad branch algorithm (“Broad Branch”).

TABLE 14
Plan lower-level SKUs in the usual way. Specifically, during the netting
pass, net inventory and other scheduled supplies against the independent
demands. Create lower-level SKU supplies for the independent demand
quantities not yet satisfied. Explode these supplies to create dependent
demands for the aggregate SKUs.
For the aggregate SKUs only, use a different sort order on
the demands than
the usual sort order. Specifically, before sorting by calculated priority, first
sort by aggregation period. Then sort by calculated priority, need date,
etc., as usual. This sort order means that all the demands in the same
aggregation period will appear consecutively. Within the aggregation
period, calculated priority is more important than need date.
Proceed as usual with the netting of scheduled supplies against
demands for the aggregate SKUs.
When creating a new supply, use a new order policy that accumulates all
demands in an aggregation period to determine the quantity of the supply
order.
Once Broad Branch encounters a demand in a new aggregation period, it
will stop pegging to any new supplies from a previous
aggregation period and
instead create a new supply. In this way, Broad Branch will create excess
supply, but only within the limits of the lot-sizing quantities. Broad Brach
normally does not create excess supply.
Proceed as usual with the material and capacity planning passes.

Under aggregation logic, deep tree (low level) and broad branch (high level) algorithms may run together—for example, Broad Brach may be executed first for two complete passes and then Deep Tree may be executed after that to drill down into deeper levels of detail. The overall idea in this example is that to create artificial independent demands for the aggregate SKUs based on the dependent demands for the aggregate SKUs that exist after the first Broad Branch pass. Deep Tree may then plan these artificial independent demands. Deep Tree may not plan the independent demands for the lower-level SKUs. After Deep Tree is finished, these aggregate SKU artificial demands may be replaced by the original aggregate SKU dependent demands, and the appropriate connections may be made between the lower-level SKU supplies, as well as the aggregate SKU supplies. This logic is further described below in Table 15.

TABLE 15
After Broad Branch runs, there will be aggregate SKU supplies created in
each aggregation period where there is any aggregate SKU demand. It is
possible that there will be more than one aggregate
SKU supply (depending
on the lot-sizing quantities) and it is certainly possible that these aggregate
SKU supplies will be late, thereby making the aggregate SKU
demands late and the lower-level SKU independent demands late as well.
Before the reset after the first Broad Branch run,
look for aggregation periods
in which any aggregate SKU demand is satisfied beyond the meet late
duration. In these periods, create artificial independent demands for the
aggregate SKUs for the same quantity as all the aggregate SKU dependent
demands in that period. It is these artificial aggregate SKU independent
demands that Deep Tree will try to satisfy. Set the meet late durations on
these artificial demands to the minimum meet late duration of all the
aggregate SKU dependent demands. Also initially set these artificial
independent demands as cancelled, so that Broad Branch does not
try to plan them during its second pass.
The Broad Branch reset will be modified to leave the lower-level SKU
demands, supplies, their dependent demands, and the order pegs intact.
Specifically, change the resets as follows:
When doing the demand order resets, mark as cancelled any lower-
level SKU independent demand that occurs in an aggregation
period where any lower-level SKU independent demand is met
beyond the meet late duration. Also mark as cancelled, but do not delete,
the aggregate SKU dependent demands.
When doing the supply order resets, do not delete the lower-level
SKU supplies.
When doing the order peg resets, do not delete the order pegs
connecting the lower-level SKU independent demands to their
supplies.
Run Broad Branch on all the uncancelled independent demands, as usual.
Before running Deep Tree, mark the aggregate SKU artificial independent
demands as uncancelled, so that they will be planned by Deep Tree.
Run Deep Tree as usual, but do not plan the lower-level SKU independent
demands. Instead, plan the aggregate SKU artificial independent demands.
At the end of the Deep Tree run, before all the repegging logic described
below, find the aggregate SKU dependent demands and the artificial
independent demands in each aggregation period. Peg the dependent
demands to the same supplies that the artificial independent demands are
pegged to. Then delete the artificial independent demands.

Next, repegging logic is described in detail. In describing repegging logic, pseudo codes and examples based on one embodiment of the present invention are used. Those skilled in the art would appreciate that the present invention is not limited by these pseudo codes and examples and would know other algorithms and/or codes may be used to implement repegging logic of the present invention.

Supplies may need to be repegged to demands either because demand exceeds supply, because supply exceeds demand, or because of multiple supply orders. In repegging supplies to demands, new order pegs may be added.

Applying repegging logic, a complete set of order pegs in each aggregation period may be constructed, where the term “complete” means that each supply is pegged to each demand in that aggregation period. However, in the case where demand exceeds supply and demand is to be satisfied by calculated priority, repegging logic does not result in a complete set of order pegs. Specifically, in that case, all demands that are at least partially satisfied may be pegged to all supplies, but demands that are completely unsatisfied may still not be pegged to any supplies even after applying all the repegging logic.

The logic (or algorithm) described below creates a complete set of order pegs between all demands and all supplies in an aggregation period as long as the rule is not to spread undersupply by calculated priority. If the rule is to spread undersupply evenly, it pegs all demands in an aggregation period with some filled quantity to all supplies in the same aggregation period.

```
TABLE 16
BuildCompleteOrderPegs
for each demand order dmd in an aggregation period
  if (!spreadUndersupplyByCalcPriority or dmd.getQtyUnfilled( ) <
  dmd.getQty(
))
    buildCompleteOrderPegsOnDmd(dmd);
  end
end
```

TABLE 17

```
BuildCompleteOrderPegsOnDmd
for each supply order sup in aggregation period
  match = false;
  for each order peg orderPeg on dmd and while not match
    pegSup = orderPeg.getSupplyOrder( );
    if pegSup matches sup
      match = true
    end
  end
  if not match
    add newOrderPeg between sup and dmd
    newOrderPeg.setQty(0)
  end
end
```

Even after running the methods shown in Tables 16 and 17, order pegs may still need to be added in the case where undersupply is spread by calculated priority and some demands with the same calculated priority are at least partially filled while others are unfilled

If more than one supply order satisfies the aggregate SKU demands in a single aggregation period, then the demands may be pegged to the supplies in a way that parallels the percentage of the total supply provided by each supply order as shown in Table 18.

```
TABLE 18
if the plan includes Aggregate SKUs
  for all SKUs
    if the current SKU is an Aggregate SKU
      for each aggregation period
        buildCompleteOrderPegs( );
        if there is more than one supply order
          repegMultipleSupplyOrders( );
        end
        // insert logic for identify excess supply or undersupply here
      end
    end
  end
end
RepegMultipleSupplyOrders
determine totDmdQty in aggregation period
determine totSupQty in aggregation period
if (totSupQty < totDmd & !spreadUndersupplyByCalcPriority)
  // supply does not meet demand and we spread undersupply
  proportionally or
evenly
  for each supply order sup in aggregation period
    // fraction is based on total demand provided by this supply order.
    repegRatio = (sup.getQty( ) − sup.getQtyUnfilled( )) / totDmdQty;
    for each order peg orderPeg on sup
      dmd = orderPeg.getDemandOrder( );
      orderPeg.setQty(repegRatio * dmd.getQty( );
    end
  end
else
  // supply meets or exceeds demand, or we spread undersupply
  by calculated
priority
  for each supply order sup in aggregation period
    // fraction is based on total supply provided by this supply order
    repegRatio = (sup.getQty( ) − sup.getQtyUnfilled( )) / totSupQty;
    for each order peg orderPeg on sup
      dmd = orderPeg.getDemand( );
      orderPeg.setQty(repegRatio * (dmd.getQty( ) − dmd.
      getQtyUnfilled( ));
    end
  end
end
```

Examples 1, 2, 3 and 4 are used to describe the logic shown above.

### EXAMPLE 1

### More Than One Supply Order, Supply Equals Demand

In this example, it is assumed that there are four demand orders, for quantities 200, 300, 400 and 600, respectively, and two supply orders, one for quantity 1000 and one for quantity 500. Tables 19 and 20 show the order pegs before and after multiple-supply-order repegging, respectively. As shown in Table 20, each demand gets ⅔ of its supply from supply order 1, and ⅓ of its supply from supply order 2.

TABLE 19

| Dmd | Supply | PeggedQty |
|---|---|---|
| 1 | 1 | 200 |
| 1 | 2 | 0 |
| 2 | 1 | 300 |
| 2 | 2 | 0 |
| 3 | 1 | 400 |
| 3 | 2 | 0 |
| 4 | 1 | 100 |
| 4 | 2 | 500 |

TABLE 19

| Dmd | Supply | PeggedQty |
|---|---|---|
| 1 | 1 | 133.33 |
| 1 | 2 | 66.67 |
| 2 | 1 | 200 |
| 2 | 2 | 100 |
| 3 | 1 | 266.67 |
| 3 | 2 | 133.33 |
| 4 | 1 | 400 |
| 4 | 2 | 200 |

### EXAMPLE 2

### More Than One Supply Order, Supply Exceeds Demand

In this example it is assumed that there are four demand orders, for quantities 200, 300, 400 and 600, respectively and two supply orders, one for quantity 1000 and another for quantity 1000. Tables 21 and 22 show the order pegs before and after multiple-supply-order repegging. In this example, each demand gets half of its supply from supply order 1, and half of its supply from supply order 2. The excess supply in this example is not redistributed, but may be redistributed later using, for example, the excess-supply-repegging logic. The pegs on each demand sums to the demand quantity.

TABLE 20

| Dmd | Supply | PeggedQty |
|---|---|---|
| 1 | 1 | 200 |
| 1 | 2 | 0 |
| 2 | 1 | 300 |
| 2 | 2 | 0 |
| 3 | 1 | 400 |
| 3 | 2 | 0 |
| 4 | 1 | 100 |
| 4 | 2 | 500 |

TABLE 22

| Dmd | Supply | PeggedQty |
|---|---|---|
| 1 | 1 | 100 |
| 1 | 2 | 100 |
| 2 | 1 | 150 |
| 2 | 2 | 150 |
| 3 | 1 | 200 |
| 3 | 2 | 200 |
| 4 | 1 | 300 |
| 4 | 2 | 300 |

### EXAMPLE 3

### More Than One Supply Order, Demand Exceeds Supply, Spread Undersupply Evenly or Proportionally

In this example, it is assumed that there are four demand orders, for quantities 200, 300, 400 and 600, respectively, and two supply orders, one for quantity 500 and one for quantity 300. Tables 23 and 24 show the order pegs before and after multiple-supply-order repegging, respectively. In this example, each demand has 800/1500=53.33% of its demand satisfied and gets ⅝ of its supply from supply order 1, and ⅜ of its supply from supply order 2. The undersupply in this example is spread proportionally. If the rule is to spread undersupply evenly, the undersupply may be correctly redistributed later using, for example, the undersupply repegging logic.

TABLE 23

| Dmd | Supply | PeggedQty |
|---|---|---|
| 1 | 1 | 200 |
| 1 | 2 | 0 |
| 2 | 1 | 300 |
| 2 | 2 | 0 |
| 3 | 1 | 0 |
| 3 | 2 | 300 |
| 4 | 1 | 0 |
| 4 | 2 | 0 |

TABLE 24

| Dmd | Supply | PeggedQty |
|---|---|---|
| 1 | 1 | 66.67 |
| 1 | 2 | 40 |
| 2 | 1 | 100 |
| 2 | 2 | 60 |
| 3 | 1 | 133.33 |
| 3 | 2 | 80 |
| 4 | 1 | 200 |
| 4 | 2 | 120 |

### EXAMPLE 4

### More Than One Supply Order, Demand Exceeds Supply, Spread Undersupply By Calculated Priority

In this example, it is assumed that there are four demand orders, for quantities 200, 300, 400 and 600, respectively, and two supply orders, one for quantity 500 and one for quantity 300. Tables 25 and 26 show the order pegs before and after multiple-supply-order repegging, respectively.

In the logic described above, repegging of multiple supply orders are based on the aggregate SKU demands, not on the lower-level SKU demands. If some of the lower-level SKU demands are satisfied through inventory or scheduled supplies of the lower-level SKU, then the aggregate SKU demands may not have the same quantities as the lower-level SKU demands.

TABLE 25

| Dmd | Supply | PeggedQty |
|---|---|---|
| 1 | 1 | 200 |
| 1 | 2 | 0 |
| 2 | 1 | 300 |
| 2 | 2 | 0 |
| 3 | 1 | 0 |
| 3 | 2 | 300 |

TABLE 26

| Dmd | Supply | PeggedQty |
|---|---|---|
| 1 | 1 | 125 |
| 1 | 2 | 75 |
| 2 | 1 | 187.5 |
| 2 | 2 | 112.5 |
| 3 | 1 | 187.5 |
| 3 | 2 | 112.5 |

Next, the case in which supply exceeds demand is examined. Supply may exceed demand when lot-sizing forces the planning algorithms to create more supply than what is strictly necessary. This may happen in the case where there is only one supply order satisfying all the aggregate SKU demand in an aggregation period, and also in the case where there are multiple supply orders satisfying demand.

To determine whether there is an excess supply, one may iterate over all supply orders and accumulate their filled quantities to determine the total supply. To determine the total demand quantity, one may iterate over all the order pegs on each supply order and accumulate their quantities. Here, the order peg quantities, not the demand quantities are accumulated, because it is possible for the same demand order to be pegged to more than one supply order. This logic may not be applicable to identify the case where demand exceeds supply, because some demands might not be pegged to any supplies.

Table 27 shows pseudo-code representative of an algorithm that may be used after identifying multiple supply orders.

TABLE 27

```
totSupQty = 0;
totPeggedDmdQty = 0;
for each supply order sup in this aggregation period
  totSupQty += (sup.getQty( ) − sup.getQtyUnfilled( ));
  for each order peg orderPeg on sup
    totPeggedDmdQty += orderPeg.getQty( );
  end
end
if (totSupQty > totPeggedDmdQty)
  if excess supply rule is by aggregate sku profile
    repegExcessSupplyByProfile(totSupQty −
    totPeggedDmdQty, totSupQty);
  else if excess supply rule is proportional
    repegExcessSupplyProportionally(totSupQty −
totPeggedDmdQty,totDmdQty);
  else
    repegExcessSupplyEvenly(totSupQty − totPeggedDmdQty);
  end
else
  // insert logic to identify undersupply here
end
```

In this algorithm, the minimum ship requirement is to spread the excess supply according to an aggregate SKU profile. Alternatively, one may spread the excess supply either proportionally or evenly.

Next, the logic for aggregating SKU profiles is described. For each aggregate SKU, there may be an associated aggregate SKU profile. This profile may have two collections—one collection of pointers to the associated lower-level SKUs and one collection of percentages for these lower-level SKUs.

This repegging requirement may be complicated by the fact that, in a given aggregation period, one may not have independent demands for all lower-level SKUs. For example, the complete set of sizes in the aggregate SKU profile might be S, M, L, and XL, but in a given aggregation period, there may be demands for only M, L, and XL lower-level SKUs. One may need to know what sizes are included in each aggregate supply so that, for example, the cutting factory would know how many of each size to cut. To deal with this problem, independent demand links may be used to support this lower-level SKU view into the aggregate supplies. In so doing, a new independent demand for the missing lower-level SKUs may be created.

If there is more than one demand for a given lower-level SKU in a single aggregation period (for example, if there are two demands for size L), then all the excess supply for that lower-level SKU may be pegged to one of these demands. Here, the repegging requirement may be complicated by the fact that, in a single aggregation period, one may have more than one supply order. The excess supply may be distributed over the multiple supply orders in a ratio that matches the ratio already established by the logic for multiple supply orders. If there is more than one demand for a given lower-level SKU and more than one supply order for the aggregate SKU in the same aggregation period, all the excess supply for that lower-level SKU may be pegged to one of these demands.

Table 28 shows an algorithm for repegging excess supply in the aggregate SKU profile. The algorithm may be used to repeg supplies to demands so that all excess supply is pegged using aggregate SKU profile. If no demands exist for some lower-level SKU, the algorithm creates lower-level demand and supply and pegs supply to demand. It also creates aggregate SKU demand as dependent demand of lower-level SKU supply. In the algorithm, a variable “excessSupQty” contains excess supply quantity in aggregation period and a variable “totSupQty” contains total supply quantity in aggregation period.

```
TABLE 28
RepegExcessSupplyByProfile
for each lower-level SKU llSKU in aggregate SKU profile
  get llPercent for this llSKU
  addQty = excessSupQty * llPercent;
  done = false;
  for each demand dmd for aggregate SKU in aggregation
  period and while not
done
    parentSup = dmd.getParentSupply( );
    parentSKU = parentSup.getSKU( );
    if parentSKU matches llSKU
      if dmd has only one order peg orderPeg
        sup = orderPeg.getSupplyOrder( );
        orderPeg.setQty(orderPeg.getQty( ) + addQty);
      else
        for each order peg orderPeg on dmd
          pegAddQty = addQty * orderPeg.getQty( ) / dmd.getQty( );
          orderPeg.setQty(orderPeg.getQty( ) + pegAddQty)
        end
      end
      done = true;
    end
  end
  if not done // no demand for lower-level sku in this period,
  so create one (ugh!)
    create new independent demand llDmd for llSKU with
    quantity equal to
addQty
    create new supply llSup for llSKU with quantity equal to addQty
    peg llDmd to llSup with peg quantity equal to addQty
    create new dependent demand depDmd for aggregate
    SKU with quantity
equal to addQty
    if there is only one supply order sup in this aggregation period
      peg depDmd to sup with peg quantity equal to addQty
    else
      for each supply order sup in this aggregation period
        pegAddQty = addQty * (sup.getQty( ) − sup.
        getQtyUnfilled( )) / totSupQty;
        peg depDmd to sup with peg quantity equal to pegAddQty
      end
    end
  end
end
```

### EXAMPLE 5

### More Than One Supply Order, Supply Exceeds Demand, Spread Excess Supply by Aggregate SKU Profile

In this example, there are four aggregate SKU demand orders, for quantities 200, 300, 400 and 600, respectively, and two supply orders, one for quantity 1000 and another for quantity 1000. The excess supply is 500 aggregate SKU units. Further, there are five (5) lower-level SKUs associated with the aggregate SKU, and their aggregate SKU profile is as follows:

TABLE 29

| | | Excess |
|---|---|---|
| Lower-Level | | Supply |
| SKU | Profile | Quantity |
| 1 | 10% | 50 |
| 2 | 20% | 100 |
| 3 | 25% | 125 |
| 4 | 30% | 150 |
| 5 | 15% | 75 |

Tables 30 and 31 show the order pegs after multiple-supply-order repegging but before excess-supply repegging and after excess-supply repegging, respectively.

TABLE 30

| Dmd | Lower-Level SKU | Supply | PeggedQty |
|---|---|---|---|
| 1 | 1 | 1 | 100 |
| 1 | 1 | 2 | 100 |
| 2 | 2 | 1 | 150 |
| 2 | 2 | 2 | 150 |
| 3 | 3 | 1 | 200 |
| 3 | 3 | 2 | 200 |
| 4 | 4 | 1 | 300 |
| 4 | 4 | 2 | 300 |

TABLE 31

| Dmd | Lower-Level SKU | Supply | PeggedQty |
|---|---|---|---|
| 1 | 1 | 1 | 125 |
| 1 | 1 | 2 | 125 |
| 2 | 2 | 1 | 200 |
| 2 | 2 | 2 | 200 |
| 3 | 3 | 1 | 262.5 |
| 3 | 3 | 2 | 262.5 |
| 4 | 4 | 1 | 375 |
| 4 | 4 | 2 | 375 |
| 5 | 5 | 1 | 37.5 |
| 5 | 5 | 2 | 37.5 |

Each existing demand's supply in Table 31 is increased according to the calculated excess supply quantity. This excess supply quantity comes half from supply order 1 and half from supply order 2. An aggregate demand for a total of 75 units is added. This demand's supply also comes half from supply order 1 and half from supply order 2. This new aggregate demand is a dependent demand for a new independent demand for lower-level SKU 5.

Excess supply may be redistributed proportionally. Because one already has a complete set of order pegs, one only needs to iterate over the order pegs on each demand and increase each order peg's quantity according to the proportion of the total demand represented by the current order peg quantity, multiplied by the total excess supply quantity.

The algorithm in Table 32 pegs supplies to demands so that all excess supply is pegged. For each order peg, the algorithm increases quantity according to fraction of total demand represented by current order peg quantity. The algorithm has a variable “excessSupQty”, which contains excess supply quantity in aggregation period, and a variable “totDmdQty”, which contains total demand quantity in aggregation period.

TABLE 32
for each demand order dmd in aggregation period

for each order peg orderPeg on dmd

pegAddQty = excessSupply * orderPeg.getQty( ) / totDmdQty;
orderPeg.setQty(orderPeg.getQty( ) + pegAddQty);

end

end

### EXAMPLE 6

### More Than One Supply Order, Supply Exceeds Demand, Spread Excess Supply Proportionally

In this example, there are four aggregate SKU demand orders, for quantities 200, 300, 400 and 600, respectively, and two supply orders, one for quantity 1000 and another for quantity 1000. The excess supply is 500 aggregate SKU units. Tables 33 and 34 show the order pegs after multiple-supply-order repegging but before excess-supply repegging and after excess-supply repegging, respectively.

TABLE 33

| Dmd | Lower-Level SKU | Supply | PeggedQty |
|---|---|---|---|
| 1 | 1 | 1 | 100 |
| 1 | 1 | 2 | 100 |
| 2 | 2 | 1 | 150 |
| 2 | 2 | 2 | 150 |
| 3 | 3 | 1 | 200 |
| 3 | 3 | 2 | 200 |
| 4 | 4 | 1 | 300 |
| 4 | 4 | 2 | 300 |

TABLE 34

| Dmd | Supply | PeggedQty |
|---|---|---|
| 1 | 1 | 133.33 |
| 1 | 2 | 133.33 |
| 2 | 1 | 200 |
| 2 | 2 | 200 |
| 3 | 1 | 266.67 |
| 3 | 2 | 266.67 |
| 4 | 1 | 400 |
| 4 | 2 | 400 |

In Table 34, each demand gets 33.33% more supply than it requires. This excess supply quantity comes half from supply order 1 and half from supply order 2.

Excess supply may be redistributed evenly. In so doing, one may first determine the quantity by which each demand's supply should increase, which is the total excess supply divided by the number of demands. One may then iterate over the order pegs on each demand and increase each order peg's quantity accordingly to the proportion of the current demand's quantity represented by the current order peg quantity.

The algorithm of Table 35 relates supplies to demands so that all excess supply is pegged. For each demand, it increases total quantity pegged by the same quantity. For each order peg on each demand, it increases quantity according to fraction of that demand's quantity satisfied by each supply order. It has a variable “excessSupQty”, which contains excess supply quantity in aggregation period.

TABLE 35
dmdCount = 0;
for each demand order dmd in aggregation period

dmdCount++;

end
addQty = excessSupQty / dmdCount;
for each demand order dmd in aggregation period

for each order peg orderPeg on dmd

pegAddQty = addQty * orderPeg.getQty( ) / dmd.getQty( );
orderPeg.setQty(orderPeg.getQty( ) + pegAddQty);

end

end

### EXAMPLE 7

### More Than One Supply Order, Supply Exceeds Demand, Spread Excess Supply Evenly

In this example, there are four aggregate SKU demand orders, for quantities 200, 300, 400 and 600, respectively, and two supply orders, one for quantity 1000 and another for quantity 1000. The excess supply is 500 aggregate SKU units. For each demand, the excess supply is 125 aggregate SKU units. Table 36 shows the order pegs after even excess-supply repegging. In Table 36, each demand gets 125 more units of supply than it requires. This excess supply quantity comes half from supply order 1 and half from supply order 2.

TABLE 36

| Dmd | Supply | PeggedQty |
|---|---|---|
| 1 | 1 | 162.5 |
| 1 | 2 | 162.5 |
| 2 | 1 | 212.5 |
| 2 | 2 | 212.5 |
| 3 | 1 | 262.5 |
| 3 | 2 | 262.5 |
| 4 | 1 | 362.5 |
| 4 | 2 | 362.5 |

Demand may exceed supply when there are constraints in the supply chain that prevent the plan from creating all the supplies it needs at the time they are needed. The logic in Table 37 may be inserted after the logic for identifying excess supply.

TABLE 37
totDmdQty = 0;
for each demand order dmd in this aggregation period

totDmdQty += dmd.getQty( );

end
if (totSupQty < totDmdQty)

if undersupply rule is by calculated priority

repegExcessDemandByPriority(totDmdQty − totSupQty,
totSupQty);

else if undersupply rule is proportional

repegUnderSupplyProportionally(totDmdQty);

else

repegUnderSupplyEvenly(totDmdQty − totSupQty);

end

end

The available supply may be spread by calculated priority, proportionally, or evenly. Examples of algorithms associated with the three spreading methods are now described.

Both Deep Tree and Broad Branch algorithms will satisfy independent demands in order of calculated priority as described hereafter. The logic given below may come into play only when there are multiple aggregate SKU demands with the same calculated priority and the supply is sufficient to satisfy only some of these demands with the same calculated priority. In other cases (i.e., supply meets or exceeds demand, or supply runs out at an aggregate SKU demand that has a unique calculated priority), no repegging is required.

The algorithm in Table 38 sorts the demands in an aggregation period by calculated priority, and then identifies the first demand that has some quantity unfilled. If this demand has a unique calculated priority, then no repegging is required. If this demand does not have a unique calculated priority, then it accumulates the total demand quantity with the same calculated priority, as well as the total supply quantity for these demands. Finally, it fixes the order pegs so that the quantity filled on each demand matches its proportion of the total demand for that calculated priority, multiplied by the total supply for the calculated priority. If there are multiple supply orders, each order peg may reflect the proportion of the total supply for the calculated priority derived from each supply order.

```
TABLE 38
// find first unfilled demand
// also check if previous demand has same calculated priority
prevCalcPriority = −1;
calcPriorityFirstUnfilledDmd = −1;
goback = false;
for each demand dmd in aggregation period and while
calcPriorityFirstUnfilledDmd < 0
  if dmd.getQtyUnfilled( ) > 0
    calcPriorityFirstUnfilledDmd = dmd.getCalcPriority( );
    if (prevCalcPriority == calcPriorityFirstUnfilledDmd)
      goback = true;
    end
  end
  prevCalcPriority = dmd.getCalcPriority( );
end
// check if next demand has same calculated priority as well
goforward = false;
if calcPriorityFirstUnfilledDmd > 0 and dmd is not last demand in aggregation
period
  set nextDmd to next demand
  if (nextDmd.getCalcPriority( ) == calcPriorityFirstUnfilledDmd)
    goforward = true;
  end
end
// only repeg if demand on either side of first unfilled demand has matching
priority
if (goback or goforward)
  // first and last demand with matching calculated priority
  if goback
    set firstDmd to first demand with calcPriority ==
calcPriorityFirstUnfilledDmd
  else
    firstDmd = dmd;
  if goforward
    set lastDmd to last demand with calcPriority ==
calcPriorityFirstUnfilledDmd
  else
    lastDmd = dmd;
  // determine demand and supply for this calculated priority
  dmdForCalcPriority = 0;
  supForCalcPriority = 0;
  for each demand dmd between firstDmd and lastDmd
    dmdForCalcPriority += dmd.getQty( );
    for each order peg orderPeg on dmd
      supForCalcPriority += orderPeg.getQty( );
    end
  end
  // finally, redo the order pegs
  for each demand dmd between firstDmd and lastDmd
    if (dmd.getQtyUnfilled( ) == dmd.getQty( ))
      // this demand needs order pegs to all the supplies in aggregation period
      buildCompleteOrderPegsOnDmd(dmd);
    dmdQtyFilled = dmd.getQty( ) * supForCalcPriority / dmdForCalcPriority;
    dmd.setQtyUnfilled(dmd.getQty( ) − dmdQtyFilled);
    for each order peg orderPeg on dmd
      sup = orderPeg.getSupplyOrder( );
      orderPeg.setQty(dmdQtyFilled * (sup.getQty( ) − sup.getQtyUnfilled( )) /
        totSupQty);
    end
  end
  end
```

### EXAMPLE 8

### One Supply Order, Demand Exceeds Supply, Spread Undersupply By Calculated Priority

In this example, there are four demand orders, for quantities 200, 300, 400 and 600, respectively, and one supply order for 800 units. The total undersupply quantity is 700 units.

Tables 39 and 40 show examples of the order peg before and after undersupply repegging, respectively.

TABLE 39

| | | Calculated | |
|---|---|---|---|
| Dmd | Supply | Priority | PeggedQty |
| 1 | 1 | 5 | 200 |
| 2 | 1 | 10 | 300 |
| 3 | 1 | 15 | 300 |
| 4 | 1 | 15 | N/A |

TABLE 40

| | | Calculated | |
|---|---|---|---|
| Dmd | Supply | Priority | PeggedQty |
| 1 | 1 | 5 | 200 |
| 2 | 1 | 10 | 300 |
| 3 | 1 | 15 | 120 |
| 4 | 1 | 15 | 180 |

### EXAMPLE 9

### Multiple Supply Orders, Demand Exceeds Supply, Spread Undersupply By Calculated Priority

In this example, there are four demand orders, for quantities 10, 10, 20, and 5, respectively. The calculated priorities on the demands are 5, 10, 10, and 10, respectively. Further, there are three supply orders, for quantities 15, 8, and 2, respectively. The total undersupply quantity is 20 units. Table 41 shows the order pegs before multiple-supply-order repegging, but after building complete order pegs an all the demands that are at least partially filled. Table 42 shows the order pegs after multiple-supply-order-repegging. Table 44 shows the order pegs after undersupply repegging by calculated priority.

TABLE 41

| Dmd | Supply | Calculated Priority | PeggedQty |
|---|---|---|---|
| 1 | 1 | 5 | 10 |
| 1 | 2 | 5 | 0 |
| 1 | 3 | 5 | 0 |
| 2 | 1 | 10 | 5 |
| 2 | 2 | 10 | 5 |
| 2 | 3 | 10 | 0 |
| 3 | 1 | 10 | 0 |
| 3 | 2 | 10 | 3 |
| 3 | 3 | 10 | 2 |

TABLE 42

| Dmd | Supply | Calculated Priority | PeggedQty |
|---|---|---|---|
| 1 | 1 | 5 | 6.0 |
| 1 | 2 | 5 | 3.2 |
| 1 | 3 | 5 | 0.8 |
| 2 | 1 | 10 | 6.0 |
| 2 | 2 | 10 | 3.2 |
| 2 | 3 | 10 | 0.8 |
| 3 | 1 | 10 | 3 |
| 3 | 2 | 10 | 1.6 |
| 3 | 3 | 10 | 0.4 |

TABLE 43

| | | Calculated | |
|---|---|---|---|
| Dmd | Supply | Priority | PeggedQty |
| 1 | 1 | 5 | 6.0 |
| 1 | 2 | 5 | 3.2 |
| 1 | 3 | 5 | 0.8 |
| 2 | 1 | 10 | 2.571 |
| 2 | 2 | 10 | 1.371 |
| 2 | 3 | 10 | 0.343 |
| 3 | 1 | 10 | 5.143 |
| 3 | 2 | 10 | 2.743 |
| 3 | 3 | 10 | 0.686 |
| 4 | 1 | 10 | 1.286 |
| 4 | 2 | 10 | 0.686 |
| 4 | 3 | 10 | 0.171 |

Table 44 shows an algorithm used to spread available supply proportionally. Given a complete set of order pegs, one may iterate over the order pegs on each demand and set each order peg's quantity according to the proportion of the total demand represented by the current order peg's supply quantity, multiplied by the current demand quantity.

The algorithm in Table 44 repegs supplies to demands to account for undersupply. For each order peg, it sets quantity according to fraction of total demand represented by current order peg's supply quantity, multiplied by current demand quantity. The algorithm has an input variable “totDmdQty”, which contains total demand quantity in aggregation period.

TABLE 44

```
for each demand order dmd in aggregation period
  dmdRatio = dmd.getQty( ) / totDmdQty;
  dmdQtyFilled = 0;
  for each order peg orderPeg on dmd
    sup = orderPeg.getSupplyOrder( );
    supQtyFilled = sup.getQty( ) − sup.getQtyUnfilled( );
    orderPeg.setQty(supQtyFilled * dmdRatio);
    dmdQtyFilled += orderPeg.getQty( );
  end
  dmd.setQtyUnfilled(dmd.getQty( ) − dmdQtyFilled);
end
```

### EXAMPLE 10

### One Supply Order, Demand Exceeds Supply, Spread Undersupply Proportionally

In this example, there are four demand orders, for quantities 200, 300, 400 and 600, respectively, and one supply order for 800 units. The total undersupply quantity is 700 units. Tables 45 and 46 show the order peg quantities before undersupply repegging and after proportional under supply repegging.

TABLE 45

| Dmd | Supply | PeggedQty |
|---|---|---|
| 1 | 1 | 200 |
| 2 | 1 | 300 |
| 3 | 1 | 300 |
| 4 | 1 | 0 |

TABLE 46

| Dmd | Supply | PeggedQty |
|---|---|---|
| 1 | 1 | 106.67 |
| 2 | 1 | 160 |
| 3 | 1 | 213.33 |
| 4 | 1 | 320 |

### EXAMPLE 11

### More Than One Supply Order, Demand Exceeds Supply, Spread Undersupply Proportionally

In this example, there are four demand orders, for quantities 200, 300, 400 and 600, respectively, and two supply orders, one for quantity 500 and one for quantity 300. The total undersupply quantity is 700 units. Tables 47 and 48 show the order peg quantities before proportional undersupply repegging and after proportional undersupply repegging.

TABLE 47

| Dmd | Supply | PeggedQty |
|---|---|---|
| 1 | 1 | 66.67 |
| 1 | 2 | 40 |
| 2 | 1 | 100 |
| 2 | 2 | 60 |
| 3 | 1 | 133.33 |
| 3 | 2 | 80 |
| 4 | 1 | 200 |
| 4 | 2 | 120 |

TABLE 48

| Dmd | Supply | PeggedQty |
|---|---|---|
| 1 | 1 | 66.67 |
| 1 | 2 | 40 |
| 2 | 1 | 100 |
| 2 | 2 | 60 |
| 3 | 1 | 133.33 |
| 3 | 2 | 80 |
| 4 | 1 | 200 |
| 4 | 2 | 120 |

Supply may be spread evenly. The algorithm in Table 49 repegs supplies to demands to account for undersupply. For each demand, it decreases total quantity pegged by the same quantity. For each order peg on each demand, it decreases quantity according to fraction of that demand's quantity satisfied by each supply order. If some order pegs are less than the reduction quantity, then it sets quantity for these order pegs to zero and redistributes undersupply over other, larger order pegs. The algorithm uses a variable underSupQty, which contains undersupply quantity in aggregation period.

```
TABLE 49
dmdCount = 0;
for each demand order dmd in aggregation period
  dmdCount++;
end
dmdReduceQty = underSupQty / dmdCount;
dmdWithSupplyCount = 0;
unreducedQty = 0;
for each demand order dmd in aggregation period
  dmdQty = dmd.getQty( );
  if (dmdQty > dmdReduceQty)
    dmdQtyFilled = dmdQty − dmdReduceQty;
    dmdWithSupplyCount++;
  else
    dmdQtyFilled = 0;
    unreducedQty += dmdReduceQty − dmdQty;
  end
  for each order peg orderPeg on dmd
    sup = orderPeg.getSupplyOrder( );
    supRatio = (sup.getQty( ) − sup.getQtyUnfilled( )) / totSupQty;
    orderPeg.setQty(dmdQtyFilled * supRatio);
  end
  dmd.setQtyUnfilled(dmd.getQty( ) − dmdQtyFilled);
end
// now spread any unreduced quantity
while (unreducedQty > 0)
  dmdReduceQty = unreducedQty / dmdWithSupplyCount;
  dmdWithSupplyCount = 0;
  unreducedQty = 0;
  for each demand order dmd in aggregation period
    for each order peg orderPeg on dmd
      if (orderPeg.getQty( ) > 0)
        sup = orderPeg.getSupplyOrder( );
        supRatio = (sup.getQty( ) − sup.getQtyUnfilled( )) / totSupQty;
        pegReduceQty = dmdReduceQty * supRatio;
        if (orderPeg.getQty( ) >= pegReduceQty)
          orderPeg.setQty(orderPeg.getQty( ) − pegReduceQty);
          if (orderPeg.getQty( ) > 0)
            dmdWithSupplyCount++;
          dmd.setQtyUnfilled(dmd.getQtyUnfilled( ) + pegReduceQty);
        else
          unreducedQty += pegReduceQty − orderPeg.getQty( );
          dmd.setQtyUnfilled(dmd.getQtyUnfiiled( ) +
          orderPeg.getQty( ));
          orderPeg.setQty(0);
        end
      end
    end
  end
end
```

### EXAMPLE 12

### One Supply Order, Demand Exceeds Supply, Spread Undersupply Evenly

In this example, there are four demand orders, for quantities 100, 300, 400 and 600, respectively, and one supply order for 800 units. The total undersupply quantity is 600 units. Tables 50 and 51 show the order peg quantities before and after even undersupply repegging, respectively.

TABLE 50

| Dmd | Supply | PeggedQty |
|---|---|---|
| 1 | 1 | 100 |
| 2 | 1 | 300 |
| 3 | 1 | 400 |
| 4 | 1 | 0 |

TABLE 51

| | | Initial PeggedQty, | |
|---|---|---|---|
| | | before spreading | |
| Dmd | Supply | unreducedQty | Final PeggedQty |
| 1 | 1 | 0 | 0 |
| 2 | 1 | 150 | 133.33 |
| 3 | 1 | 250 | 233.33 |
| 4 | 1 | 450 | 433.33 |

### EXAMPLE 13

### Multiple Supply Orders, Demand Exceeds Supply, Spread Undersupply Evenly

In this example, there are four demand orders, for quantities 100, 300, 400 and 600, respectively. and one supply order for 500 units and one for 300 units. The total undersupply quantity is 600 units. Tables 52 and 53 show the order peg quantities before and after even undersupply repegging, respectively.

TABLE 52

| Dmd | Supply | PeggedQty |
|---|---|---|
| 1 | 1 | 33.33 |
| 1 | 2 | 20 |
| 2 | 1 | 100 |
| 2 | 2 | 60 |
| 3 | 1 | 133.33 |
| 3 | 2 | 80 |
| 4 | 1 | 200 |
| 4 | 2 | 120 |

TABLE 53

| | | Initial PeggedQty, | |
|---|---|---|---|
| | | before spreading | |
| Dmd | Supply | unreducedQty | Final PeggedQty |
| 1 | 1 | 0 | 0 |
| 1 | 2 | 0 | 0 |
| 2 | 1 | 93.75 | 83.33 |
| 2 | 2 | 56.25 | 50 |
| 3 | 1 | 156.25 | 145.83 |
| 3 | 2 | 93.75 | 87.5 |
| 4 | 1 | 281.25 | 270.83 |
| 4 | 2 | 168.75 | 162.5 |

Aggregation periods may be calculated as multiples of the aggregation duration, starting from the plan start date. For example, if the plan start date is May 15, and if SKU A has an aggregation duration of 7 days, then the first aggregation period begins May 15 and lasts until midnight, May 21. The second aggregation period begins at midnight, May 21 and lasts until midnight May 28, etc.

Different SKUs may have different aggregation durations. Aggregation periods are calculated as multiples of such durations added to the corresponding plan start date.

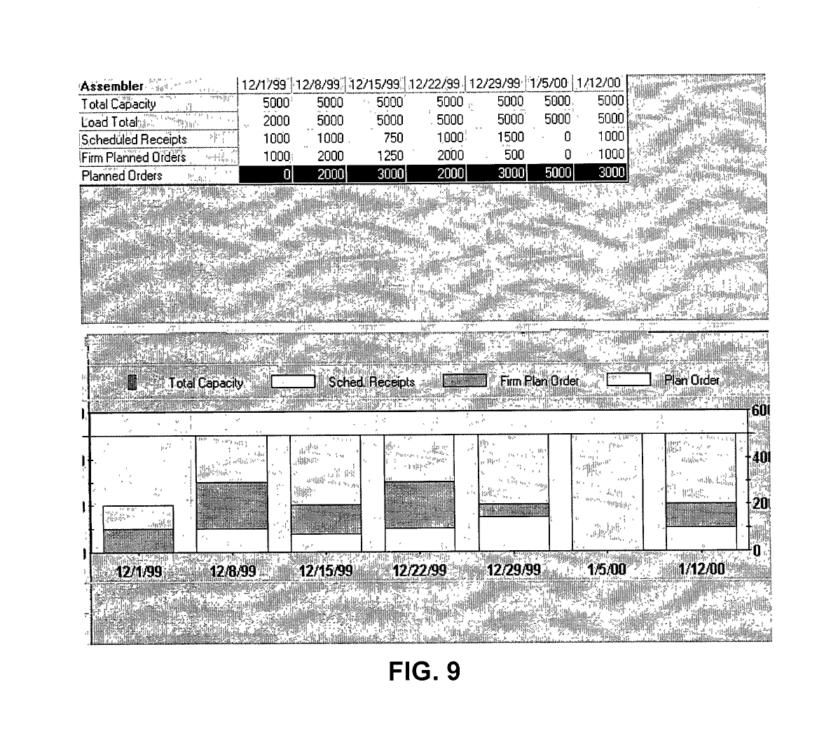

An embodiment of the present invention may provide various userviews to assist a user analyze and review information and/or plans. For example, in one userview, a user may be allowed to view supply orders and an independent demand that is pegged to each supply order. In another userview, a user may be allowed to view the resource load based on the type of supply order that is loaded in each period, allowing the user to see what parts of the load against the resource are not planned or scheduled, and therefore able to be edited, if needed. FIG. 9 contains one exemplary view of the resource load based on the type of supply order that is loaded in each period.

Resource projections may describe the loading pattern on a resource of a time in a user-defined bucket size. Projections may provide information on the total load on the resource and may be further broken into load due to each type of supply such as plan order, scheduled receipts, etc.

Various attributes may be described using supply perspective resource projections. They include maximum capacity available on the resource, total load, component load on resources (including load due to plan orders, load due to firm plan orders, load due to scheduled receipts, load due to recommended shipments, load due to firm recommended shipment, load due to vehicle load line), maximum capacity available on the resource, and total load on the resource that is an aggregate for all supplies meeting demands. A table may be used to calculate values for these attributes. For example, rows may be used to describe the load on the resource cost on a single supply order in a single planning basket. Columns may contain information regarding load details, such as a quantity when loaded, location, supply type, supply order, order id, a flag indicating plan is firm or not.

Remove Excess Feature (“Remove Excess”)

Remove excess is a feature that ensures that excess supply (or inventory) is not created within the network. The excess supply quantity may be defined as the supply in a supply chain that is not pegged to any demand.

Master planning may use demand priorities to plan supply in the situation where a higher priority demand order is needed later than a lower priority demand order, and assuming that there is no inventory or capacity issues, load sizing can create excess supply that is not pegged to any demand. Specifically, remove excess may take as an input a standard supply chain network (or master planning solution) that might include excess supplies. It then produces a net supply chain network that contains fewer excess supplies. Such a supply chain network may still include excess supplies due to factors such as firm plan orders or scheduled receipts. There may also be a small quantity of excess left after remove excess has removed what it could.

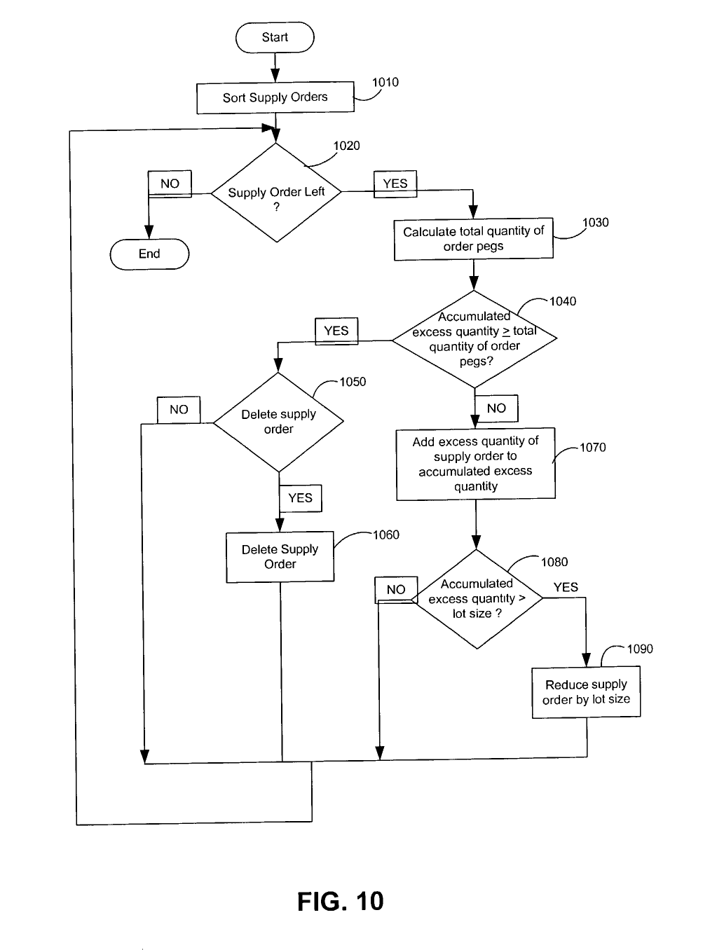

FIG. 10 illustrates an algorithm for one embodiment of the remove excess feature of the present invention. At step 1010, all supply orders are sorted increasingly according to the low-level codes of their related SKU so that it can process the supply orders level by level, starting from the finished good (i.e., the SKU closest to the customer). If the SKUs of two supply orders have the same low-level codes, they may be sorted according to their SKUs so that the same SKU's supply orders are processed consecutively to calculate the accumulated excess supply. For the same SKU's supply orders, the supplies available earlier may be processed first. After all supply orders are sorted, they are processed one by one as described below.

At step 1020, one checks whether there is a supply order that has not been processed. If there is, at step 1030 the total quantity of order pegs of such supply order is calculated. At step 1040, the total quantity is compared with the current accumulated excess quantity. If the accumulated excess quantity is greater than or equal to the total quantity of order pegs, the supply could be deleted.

At step 1050, the algorithm checks whether this supply order can be deleted or not. If the supply order can be deleted, it is deleted at step 1060. Upon deletion, order pegs of the deleted supply order may be redirected to the excess supplies. In addition, all its dependent demands and all its resource load details may be deleted. The accumulated excess quantity may be decreased by the total quantity of order pegs. If the supply order cannot be deleted (such as a firm supply order or a scheduled supply), the algorithm does nothing and just goes to process a next supply order.

If the accumulated excess quantity is less than the total quantity of order pegs, the excess quantity of this supply order may be calculated (i.e., supply quantity—total quantity of order pegs) and added to the accumulated excess quantity at step 1070.

At step 1080, the algorithm checks whether the updated accumulated excess quantity is greater than one incremental lot size. If it is, the supply order may be reduced by certain incremental lot size at step 1090. After such reduction, the supply order may still respect the lot size order policy. The resource load details may also be updated according to the load time of individual routing steps, but the start date of each routing step may not be pulled earlier even if there is a capacity that is available earlier.

Since the accumulated excess quantity may only be used for the supply orders with the same SKU, when the algorithm starts to process a supply order with a new SKU, the accumulated excess quantity may be reset to 0.

Loading Strategies:

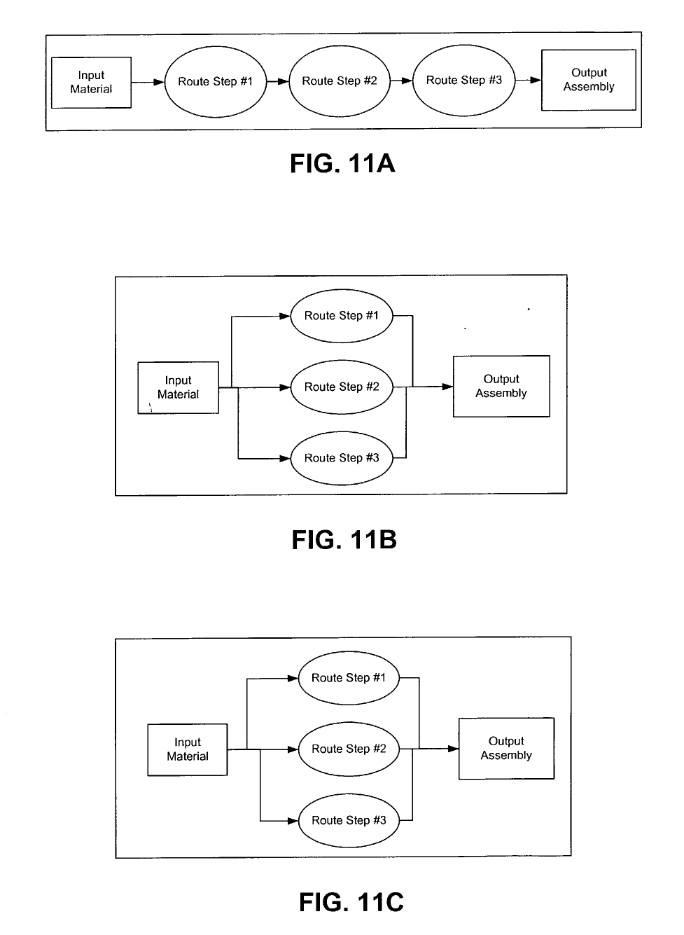

In planning capacity, master planning may use a variety of loading strategies. They include: sequential loading of resources, parallel loading of resources, variable (rate-based) lead time calculation, just in time loading of resources for Broad Branch. In sequential loading, each routing step is dependent on its predecessor's completion. FIG. 11A illustrates an example of a sequential loading. In parallel loading, each routing step is independent of one another and multiple routing steps may be used (loaded) at the same moment of time (or may not be). FIGS. 11B and 11C are examples of parallel loading.

There may be two types of parallel loading: parallel independent loading and parallel dependent loading. In parallel independent loading, each routing step is independent of one another and multiple routing steps may be used (loaded) at the same moment of time (or may not be). FIG. 11B shows an example of parallel independent loading, in which routing steps 1, 2, 3 may begin their work any time after the input material is available. The output assembly becomes available when all the routing steps have completed successfully. In parallel dependent loading, each routing step is dependent of one another that is the multiple routing steps must be used (loaded) at the same moment of time, for the same length of time. Turning to an example of parallel dependent loading shown in FIG. 11C, routing steps 1, 2, and 3 may begin their work any time after the input material is available, but when they work and how long they work for is dependent on each other. In this example, all three route steps must start and finish all at the same time. The output assembly becomes available when all the routing steps have completed successfully.

In some industries, it is common to have resources that are consumed at the exact same time within the manufacturing process. In order to model that relationship among resources within the same production method, parallel loading may be set up. This would enhance the resources that have been designated as occurring in parallel loaded at the same time.

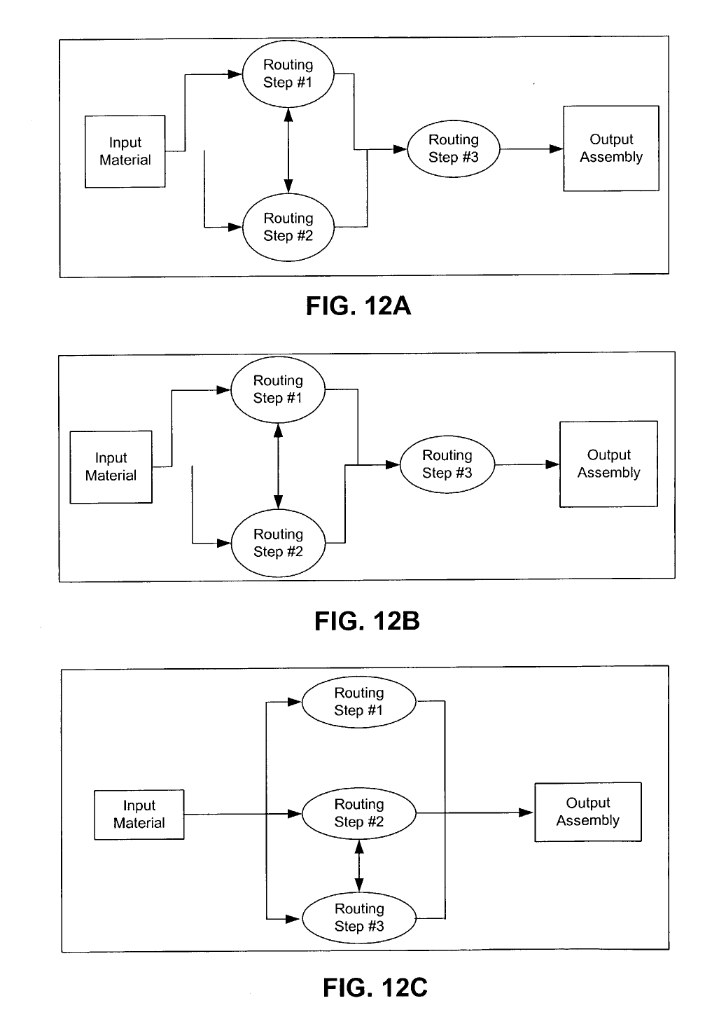

Sequential, parallel independent, and parallel dependent loadings may be combined in various manners. FIGS. 12A, 12B, and 12C show examples of such combinations. In FIG. 12A, parallel independent loading is followed by sequential loading. In FIG. 12B, parallel dependent loading is followed by sequential loading. In FIG. 12C, routing steps 1, 2 and 3 operate in parallel—routing step 1 is independent of routing steps 2 and 3, and routing steps 2 and 3 are dependent on each other.

Next, a loading strategy based on a variable (rate-based) lead time calculation is discussed. The calculated lead-time is the amount of time that it takes to plan the load caused by all the routing steps plus the SKU's buffered lead-time quantity. The planning of the load for determining the lead-time may be unconstrained following the rules of sequential, parallel independent, and parallel dependent relationships between routing steps. In other words, the actual available capacity of the resource may not be taken into consideration when calculating the lead-time of a supply order. The lead-time may be based on the total capacity that is modeled in the set up, and no consumption of the resource's capacity may occur when determining the lead-time. The actual planning of the load may be whatever the user has chosen in their planning options, either constrained or unconstrained.

When calculating the lead-time for a supply order, if the capacity available for a bucket is 0, that bucket may be skipped in the calculation of the lead-time. For a supply order that does not have any routing steps associated with its supply method, the lead-time of this order may be a defined value for the specific supply method plus the SKU's buffered lead-time quantity.

Continuous loading and batch resources may also be described in terms of lead-time. In continuous loading, the load of a supply order is not splitted over more than one bucket. Batch resources represent a continuous draw on a resource for a specified period of time.

Resources may use either forward or backward loading techniques. The forward loading technique begins at the start date of the supply order and loads resources forward. The supply orders available date is the date when the last routing step has finished its loading. The supply orders start date is the date when all of its dependent demands are satisfied. The backward loading technique begins at the supply orders need date and loads backwards. The supply orders available date is its need date. The supply orders start date is the date when the first routing step begins its loading.

For a resource-constrained plan, Broad Branch may use the forward loading technique. As mentioned earlier, with this approach, supply orders may consume enough resources early in the plan, such that the supply order is available earlier than it is required. Alternatively, for a constrained plan, Broad Branch may use the backward loading technique first on a supply order.

Ship Complete Feature (“Ship Complete”):

Customers may require an ability to specify an order as “ship complete.” An order is denoted as “ship complete,” when a customer requests to receive all of the items in the order together as one shipment.

The use of ship complete has some related costs. For example, because inventory for the ship complete order is reserved, there are inventory carrying costs associated with the delay of lower priority orders that could have been met in full.

In one embodiment of the present invention, a user may assign “ship complete” logic at two levels, i.e., order-header and order-line levels. At the order-header level, the entire order may be specified as “ship complete.” This means that the entire order is to be held until all line items on the order can be fulfilled. At the order-line level, individual line items may be specified as “ship complete.” This means that some line items can be specified as “ship complete,” while others can be shipped as partial shipments.

In implementing ship complete feature, a demand is not met until all line items are fulfilled on a “ship complete” order. The inventory that is pegged to the individual line items is held and considered part of inventory until the full customer order is met.

The order header date may show the order available when all line items on that order can be met. A user may also want to see the individual line items' availability dates so that he or she may choose to remove items that are holding up the order, for example. To make individual line items' availability dates available to a user, an exception that is tied to the order header notifying the user that the order can not be shipped complete on the date specified may be used. A user may also place an inquiry for an order.

It may also be helpful to provide a status of the “ship complete” orders. For example, as inventory is accrued to fill the order, master planning may have the ability to provide feedback on the quantity of inventory that is still outstanding before the order can be shipped.

If “ship complete” items can not be met in full, the customer may be given an option of receiving part of an order. In order to facilitate the ship complete functionality, master planning may find the highest priority line item in the ship complete order and then align the rest of the line items to the same priority. This logic enables master planning to ship items together efficiently.

To avoid inventory carrying costs, customers may be allowed to shift the manufacturing dates on available items if the need date can not be met on the entire order and the customer does not want a partial delivery.

Additional Features:

When processing orders, there are at least several additional factors that may need to be considered. They include: “set,” delivery calendar, single source customer order, and finished good alternatives.

When an order is specified as a “set,” all items of the “set” must be received before the order is shipped. A “set” requirement may be used for some or all of the order line items within an order. For example, a customer may want to specify a CPU, monitor and keyboard as a “set.” Such set requirement may be overridden, i.e., for example, a customer may request a shipment of a CPU only, when a keyboard and a monitor are not available.

A user may want to specify acceptable delivery dates for an order. This can be tying a customer profile to an order or by setting the acceptable delivery dates at the time the order is placed. This delivery date information may be tied to the order line item and/or the order header to ensure that master planning does not contradict the promise.

When promising and planning supply for customer order, it is sometimes desirable for all of the supply used to meet the demand to come from one, and only one, source location. In one embodiment of the present invention, a user may designate whether the order should have a single source.

In highly constrained supply chains, the requested item may not be available in the requested quantity on the requested date. As such, it is desirable to have a feature that enables the user to select from a list of similar products that may have availability at the previously requested date. Alternatively, this feature could be used to “up-sell” a customer on similar items.

A user may be allowed to edit supply orders, except those supply orders that fall within the freeze duration (i.e., assignments and intransits). A user may also firm and/or unfirm an order. When a supply order is deleted or a quantity is reduced, demand orders may need to be repaired or regenerated. When a new supply is added or a quantity of an existing supply order is increased, resource capacity (and/or demand orders) may also be affected.

Finally, a planning system may be designed to respond to changes in supply, demand, and/or manufacturing process. For example, a user upon seeing that a demand order is not being met due to material shortages from a certain plant, for example, may wish to override the planning system because of a known expedited shipment of the shorted material. In response, the planner may make changes to the planning system in order to pass necessary information to appropriate systems in a timely manner.

The above description of embodiments of the present invention has been given by way of examples. From the disclosure given, those skilled in the art will not only understand the present invention and its attendant advantages, but will also find apparent various changes and modifications to the embodiments. It is sought, therefore, to cover such changes and modifications as they fall within the spirit and the scope of the invention as defined by the appended claims and their equivalents.

What is claimed is:

1. A method for optimizing resource plans across a multi-location supply network, said network including locations for multiple supply points and at least one location for a demand point wherein said supply point provides supply items needed by said demand point according to said resource plans, said method comprising:
creating planning data, planning data containing information regarding constrained resources, said constrained resources including vessel scheduling information for transporting said supply items from said supply points to said demand point;
creating planning rules based on user-defined strategies, said planning rules identifying acceptable timeframes in which supplies of said supply items must arrive at said demand point in order to meet consumption dates for given orders;
generating a plan based on the planning data and the planning rules, wherein the plan optimally allocates the constrained resources according to the user-defined strategies, said plan providing required consumption dates of said supply items; and
revising the plan in real-time.

2. The method of claim 1, further comprising:
publishing the plan; and
implementing the plan by issuing commands in the multiple networks.

3. The method of claim 2, wherein the publishing step further comprises issuing one or more alerts.

4. The method of claim 1, wherein the plan includes orders for supply items from said supply points, and wherein said planning rules include shipping schedules for available shipping alternatives.

5. The method of claim 4, wherein said shipping alternatives comprise shipping routes for alternative shipping carriers.

6. The method of claim 5, wherein one of said alternative shipping carriers is designated as the preferred carrier.

7. The method of claim 5, wherein said alternative shipping carriers are prioritized such that in said plan more preferred carriers are selected over less preferred carriers when possible.

8. The method of claim 1, wherein the constrained resources include materials, capacities, inventories, transportation resources, and distribution resources.

9. The method of claim 1, wherein the revising step takes into account user inputs and real-time events including production breakdowns, distribution delays, and material shortages occurring within the multiple networks.

10. The method of claim 1, wherein the revising step further comprises revising said plan until said consumption dates can be met.

11. The method of claim 1, wherein the revising step further comprises:
validating the plan; and
repairing the plan.

12. The method of claim 1, wherein the generating step also considers one or more aggregate stock keeping units.

13. The method of claim 1, wherein the generating step uses one or more loading strategies.

14. The method of claim 13, wherein the one or more loading strategies include sequential loading, parallel loading, variable lead-time calculation, and just-in-time loading.

15. The method of claim 1, wherein the generating step considers one or more ship-complete orders.

16. The method of claim 1, wherein the generating step further comprises:
minimizing an excess, including an inventory excess and a supply excess.

17. The method of claim 16, wherein minimizing said excesses is accomplished by pegging said demands according to said planning rules.

18. The method of claim 16, wherein the dynamic factors include shipping calendars, receiving calendars, effectivity calendars, manufacturing availability calendars, and constraint settings.

19. A system for optimizing resource plans across a multi-location supply network, said network including locations for multiple supply points and at least one location for a demand point wherein said supply point provides supply items needed by said demand point according to said resource plans, said system comprising:
means for creating planning data, planning data containing information regarding constrained resources, said constrained resources including vessel scheduling information for transporting said supply items from said supply points to said demand point;
means for creating planning rules based on user-defined strategies, said planning rules identifying acceptable timeframes in which supplies of said supply items must arrive at said demand point in order to meet consumption dates for given orders;
means for generating a plan based on the planning data and the planning rules, wherein the plan optimally allocates the constrained resources according to the user-defined strategies, said plan providing required consumption dates of said supply items; and
means for revising the plan in real-time.

20. A computer program product comprising a computer useable medium having computer readable code embodied therein for optimizing resource plans across a multi-location supply network, said network including locations for multiple supply points and at least one location for a demand point wherein said supply point provides supply items needed by said demand point according to said resource plans, said code having instructions comprising:
creating planning data, planning data containing information regarding constrained resources, said constrained resources including vessel scheduling information for transporting said supply items from said supply points to said demand point;
creating planning rules based on user-defined strategies, said planning rules identifying acceptable timeframes in which supplies of said supply items must arrive at said demand point in order to meet consumption dates for given orders;
generating a plan based on the planning data and the planning rules, wherein the plan optimally allocates the constrained resources according to the user-defined strategies, said plan providing required consumption dates of said supply items; and
revising the plan in real-time.
